(19) United States
(12) Patent Application Publication
(10) Pub. No.: US 2025/0259093 A1
(43) Pub. Date: Aug. 14, 2025

(54) QUANTUM COMPUTING SYSTEM AND METHOD FOR SCALING VARIATIONAL QUANTUM PHASE ESTIMATION

(71) Applicant: Quantiuum Ltd, London (GB)

(72) Inventors: Maria-Andreea Filip, Cambridge (GB); David Munoz Ramo, Cambridge (GB); Nathan Fitzpatrick, Cambridge (GB)

(21) Appl. No.: 19/196,639

(22) Filed: May 1, 2025

Related U.S. Application Data
(63) Continuation of application No. PCT/GB2023/052868, filed on Nov. 2, 2023.
(60) Provisional application No. 63/382,086, filed on Nov. 2, 2022.

(51) Int. Cl. G06N 10/60; G06N 10/20; G06N 10/40

(52) U.S. Cl. CPC G06N 10/60; G06N 10/20; G06N 10/40

(57) ABSTRACT

A quantum computing system includes a classical computer coupled in combination with a quantum computing system, wherein the quantum computing system is configurable to execute program instructions to process input data to generate corresponding output data including eigne states of a quantum system. The quantum computing system is configured to execute a variational quantum phase estimation (VQPE) algorithm by executing a sequence of quantum operations including generation of time evolved-states and diagonalizing a Hamiltonian of the quantum system. The quantum computing system may also execute a variational fast forwarding algorithm (VFF) when generating the time evolved states.

### PRIORITY CLAIM

This application is a continuation of International Patent Application No. PCT/GB2023/052868, filed on Nov. 2, 2023, entitled “QUANTUM COMPUTING SYSTEM AND METHOD FOR SCALING VARIATIONAL QUANTUM PHASE ESTIMATION” which claims the priority benefit of U.S. Provisional Patent Application No. 63/382,086, entitled QUANTUM COMPUTER SYSTEM AND METHOD FOR SCALING VARIATIONAL QUANTUM EIGENSOLVER, filed on Nov. 2, 2022. Each of the above-referenced applications is hereby incorporated herein by reference in its entirety.

### TECHNICAL FIELD

The present disclosure relates to quantum computing methods and systems that reduce quantum resources used for certain computational tasks and enable implementation of the corresponding circuits and algorithms on noisy intermediate scale quantum (NISQ) devices. In particular the present disclosure relates to quantum computing methods and systems for determining the energy eigenstates of molecular systems for quantum chemistry applications. Furthermore, the present disclosure relates to software products, for example stored in a non-transitory memory, wherein the software products are executable on quantum computing hardware to implement aforesaid methods.

### BACKGROUND

Classical computers rely on binary logic based on binary variables, and logical operations to perform computational tasks. Contemporary classical computers use silicon-based semiconductor devices and circuits to store and process binary data and perform logical operations. While such classical binary computers have become progressively faster and more compact in recent years, execution of certain computational tasks on classical computers is still challenging due to the volume of operations and data involved in these tasks. Quantum computers have enabled a paradigm shift in computer technology by exploiting quantum phenomena such as superposition and entanglement that not only increase the computation speed compared to classical computers, but also can provide solutions to computationally complex problems that cannot be solved by classical computers, at least within timeframes suitable for practical applications. Quantum computing algorithms can be executed on quantum computers that use a variety of platforms and physical phenomena to implement quantum operations and evaluate quantum data. However, nearly all quantum computers are limited by noise and resulting decoherence in quantum states. As such, quantum computing algorithms have to be carefully constructed taking into account this limitation.

### SUMMARY

The present disclosure seeks to provide a technical solution to a technical problem of determining an energy eigenstate (e.g., ground state) of a quantum system (e.g., a molecule) using a combination of calculations performed by a classical computer (e.g., a digital computer) and quantum operations performed by a quantum computer. The present disclosure seeks to provide a technical solution to implementation of variational quantum phase estimation (VQPE) algorithm on a quantum computing system comprising a classical and a quantum computer. The disclosed VQPE algorithms include classical and quantum computing steps where the quantum computing steps can be performed by noisy intermediate scale quantum circuits. Additionally, the present disclosure seeks to provide a technical solution to reducing noise arising in these quantum circuits by reducing a number of operations or steps performed by the quantum computer for determining the energy of eigenstates of a quantum system (e.g., a molecule) using a VQPE algorithm. To this end, a modified VQPE is provided that uses a variational fast forwarding (VFF) method for approximating the time-evolution of the quantum system. The VFF method may include steps performed to generate a subspace for diagonalizing the Hamiltonian whose energy eigen states are calculated.

A quantum computing system includes at least one classical computing apparatus (also referred to as a classical computer) coupled to at least one quantum computing apparatus (also referred to as a quantum computer), wherein the classical computing apparatus and the quantum computing apparatus are configured to exchange data therebetween to execute a computing task for determining the energy of eigenstates of a quantum system (e.g., a molecular system) represented in input data provided in operation to the classical computing apparatus. The classical computing apparatus may include an input interface for receiving the input data from a user or another apparatus and an output interface to provide output data to a user or transfer the output data to another apparatus.

According to a first aspect, the quantum computing system may determine the energy of eigenstates of a Hamiltonian (e.g., a chemistry Hamiltonian) using a quantum circuit-based implementation of a variational quantum phase estimation (VQPE) algorithm based on Trotterized time propagation. Additionally a Hadamard test may be used to generate the eigenstates. The energy of eigenstates are computed by the classical computer using the results generated by the quantum computer, and then output by the classical computing apparatus. The results are computed at least in part in response to a portion of computational tasks provided to the quantum computing apparatus from the classical computing apparatus based upon the input data. The quantum computing system is configured (e.g., by the classical computer) based on an ansatz and a Hamiltonian which may be included in the input data. In some cases, one or both of the ansatz and the Hamiltonian may be stored in a memory of the quantum computing system. A Hamiltonian is often used as a representation of a quantum system—in particular the total energy of a quantum system. Hamiltonians can be used to describe the problem to be solved or simulated in a quantum computer. An ansatz is a parameterised trial solution, which may be used in variational quantum algorithms to find an approximate solution to the problem described in the Hamiltonian. Thus, an ansatz may describe a parameterized quantum circuit or wavefunction that is designed to capture the essential features of the solution; the ansatz may be used as a starting point and its parameters can be adjusted iteratively to minimize a cost function.

In one implementation of the described system, the classical computer generates a Trotter-Suzuki approximation to the time evolution operator used in the VQPE algorithm and encodes the Trotterized time evolution operator in a quantum circuit in the quantum computer. The quantum computer evolves a reference state (e.g., associated with the ansatz) via multiple time steps by executing the quantum circuit. A measurement quantum circuit generates the matrix elements of the Hamiltonian and/or an overlap matrix in a subspace (e.g., a Krylov subspace). The classical computer receives the matrix elements and generates the eigenstates of the Hamiltonian using the matrix elements.

According to a second aspect, the quantum computing system may determine the energy of eigenstates of a Hamiltonian (e.g., a chemistry Hamiltonian) using a quantum circuit-based implementation of an approximation to variational quantum phase estimation (VQPE) algorithm using variational fast forwarding (VFF) approach. Additionally a Hadamard test may be used to generate the energy eigenstates. The energy of eigenstates are computed by the classical computer using the results generated by the quantum computer, and output by the classical computing apparatus. The results are computed at least in part in response to a portion of computational tasks provided to the quantum computing apparatus from the classical computing apparatus based upon the input data. The quantum computing system is configured (e.g., by the classical computer) based on a Hamiltonian included in the input data. In some cases, one or both of the Hamiltonian may be stored in a memory of the quantum computing system.

The classical computer generates a Variational Fast Forwarding (VFF) approximation to the time evolution operator used in the VQPE algorithm and encodes the approximated time evolution operator in a quantum circuit in the quantum computer. The approximated time evolution operator comprises a controlled time evolution operator compiled using VFF and number conserving gates. The quantum computer evolves a reference state via multiple time steps by executing the quantum circuit to generate time-evolved states. A measurement quantum circuit generates the elements of matrices in a subspace. The measurement circuit comprises the quantum circuits that generates the time-evolved states. The classical computer receives the matrix elements and generates the eigenstates of the Hamiltonian using the matrix elements.

According to a third aspect, a quantum computing system is configured to determine an energy of an eigenstate of a quantum system, the quantum computing system comprising a quantum computer and a classical computing system in communication with the quantum computer. The quantum computer includes quantum gates configured to act on qubits to generate processed qubits, wherein the quantum gates are usable for building quantum circuits. The quantum computer further includes a measuring device configured to determine states of the processed qubits to generate measurement data. The classical computing system includes a non-transitory memory configured to store specific computer-executable instructions and a hardware processor in communication with the non-transitory memory where the hardware processor is configured to execute the specific computer-executable instructions to: receive input data, configure a first quantum circuit to generate time evolved quantum states, configure a second quantum circuit using the first quantum circuit to determine a matrix element of at least a Hamiltonian representing the quantum system using the time evolved quantum states, and generate the eigenstate using the matrix element. The hardware processor may configure one or both of the first and the second quantum circuits based at least in part on the input data.

In some implementations, the hardware processor may process the input data to generate a Trotter-Suzuki approximation of a time evolution operator associated with the Hamiltonian and the first quantum circuit may include the Trotter-Suzuki approximation of the time evolution operator.

In some other implementations, the hardware processor may configure the first quantum circuit by compiling an approximated time evolution operator based on Variational Fast Forwarding (VFF) and using the input data. The approximated time evolution operator, generated using VFF, may include an evolution operator (e.g., a controlled evolution operator) expressed as WDⁿW^{†} where W is a unitary operator, W^{†} is the conjugate of W, and D is a diagonal operator. W can be a time propagation operator and D can be an operator corresponding to a duration of the time evolution. W can be parametrised using a symmetry preserving ansatz. The quantum gates used to implement WDⁿW^{†} are number preserving gates and may not cause symmetry and spin contamination. Advantageously, the quantum circuit implementation of the controlled evolution operator is number preserving and thereby reduces resources used for each time evolution step.

According to a fourth aspect, there is provided a method for operating a computing system. The computing system includes a quantum computer in communication with a classical computing system, where the classical computing system includes a non-transitory memory configured to store specific computer-executable instructions, and a hardware processor in communication with the non-transitory memory. The method may include, e.g., by the hardware processor of the classical computing system:
i. receiving input data,
ii. configuring a first quantum circuit, based at least in part on the input data;
iii. generating time evolved quantum states using the first quantum circuit;
iv. configuring a second quantum circuit, based at least in part on the input data;
V. determining a matrix element of at least a Hamiltonian representing the quantum system, using the second quantum circuit and the time evolved quantum states;
vi. generating the eigenstate using the matrix element.

In some implementations, the method may include processing the input data to generate a Trotter-Suzuki approximation of a time evolution operator associated with the Hamiltonian, and configuring the first quantum circuit includes configuring the first quantum circuit using the Trotter-Suzuki approximation of the time evolution operator.

In some other implementations, the hardware processor may configure the first quantum circuit by compiling an approximated time evolution operator based on Variational Fast Forwarding (VFF) and using the input data. The approximated time evolution operator, generated using VFF, may include an evolution operator (e.g., a controlled evolution operator) of the form WDⁿ W^{†} wherein W is a unitary operator, D is a diagonal operator, and n is a number of evolution time steps. W can be a time propagation operator and D can be an operator corresponding to a duration of the time evolution. W can be parametrised using a symmetry preserving ansatz. The quantum gates used to implement WDⁿ W^{†} are number preserving gates and may not cause symmetry and spin contamination. Advantageously, the quantum circuit implementation of the controlled evolution operator is number preserving and thereby reduces resources used for each time evolution step.

According to a fifth aspect, there is provided a quantum computing system including a combination of a classical computing apparatus coupled to a quantum computing apparatus, where the classical computing apparatus and the quantum computing apparatus are configured to exchange data therebetween to execute a computing task for providing a simulation of a chemical system represented in input data provided in operation to the classical computing apparatus. The simulation is provided from the classical computing device using computed output results generated by the quantum computing apparatus in response to computational tasks being provided to the quantum computing apparatus from the classical computing apparatus based upon the input data. The quantum computing system is configured to generate a Hamiltonian and an ansatz based on a fermionic representation of the chemical system derived from the input data and wherein the quantum computing apparatus is configured to execute a quantum circuit derived from the ansatz and the Hamiltonian to compute one or more eigenvalues (e.g., energy levels) for use in generating the output results. The quantum computing apparatus is configured to evaluate the quantum circuit to compute the one or more eigenvalues representative of the chemical system by using a combination of variational quantum phase estimation (VQPE) and variational fast forwarding (VFF) method.

The invention is of advantage in that a combination of variational quantum phase estimation (VQPE) and variational fast forward (VFF) computations is effective to generate one or more eigenvalues, wherein the one or more eigenvalues are representative of properties of the chemical system.

In some cases, the quantum computing system is configured to compute the variational phase estimation based on states generated by the variational fast forward computation. For example, the quantum computing system may generate one or more time-evolved states using VFF for use in the variational phase estimation by using a state-vector simulation of the Hamiltonian.

In some embodiments, the quantum computing system is configured to use a symmetry-preserving ansatz for the ansatz used to generate a quantum circuit to be executed by the quantum computing apparatus.

In some embodiments, the quantum computing system is configured to use number preserving gates in a quantum circuit (e.g., a quantum circuit for controlled evolution) to be executed by the quantum computing apparatus.

According to a sixth aspect, there is provided a method for using a quantum computing system, wherein the quantum computing system includes a combination of a classical computing apparatus coupled to a quantum computing apparatus, wherein the method includes:
(i) configuring the classical computing apparatus and the quantum computing apparatus to exchange data therebetween to execute a computing task for providing a simulation of a chemical system represented in input data provided in operation to the classical computing apparatus;
(ii) configuring the quantum computing system to generate a Hamiltonian and an ansatz based on a fermionic representation of the chemical system derived from the input data;
(iii) configuring the quantum computing apparatus to execute a quantum circuit derived from the ansatz and the Hamiltonian to generate the output results; and
(iv) configuring the quantum computing system to provide the simulation from the classical computing device using computed output results including one or more eigenvalues generated by the quantum computing apparatus in response to computational tasks being provided to the quantum computing apparatus from the classical computing apparatus based upon the input data;
The method further includes:
(v) configuring the quantum computing apparatus to evaluate the quantum circuit to compute the one or more eigenvalues representative of the chemical system by using a combination of variational quantum phase estimation (VQPE) and variational fast forward (VFF) computations.

In some cases, the method may include configuring the quantum computing system to compute the variational phase estimation based on states generated by the variational fast forward computation. More optionally, the method includes configuring the quantum computing system to generate one or more initial time-evolved states for use in the variational phase estimation by using a state-vector simulation of the Hamiltonian.

In some cases, the method includes configuring the quantum computing system to use a symmetry-preserving ansatz for the ansatz used to generate the quantum circuit to be executed by the quantum computing apparatus.

According to a seventh aspect, there is provided a quantum circuit that is representative of a chemical system as generated using the method of the sixth aspect, wherein the quantum circuit is arranged to compute the one or more eigenvalues representative of the chemical system by using a combination of variational quantum phase estimation (VQPE) and variational fast forward (VFF) computations.

According to an eight aspect, a quantum computing system is configured to determine an energy of an eigenstate of a quantum system, the quantum computing system includes: a quantum computer comprising and a classical computing system. The quantum computer includes quantum gates configured to act on qubits to generate processed qubits, where the quantum gates are usable for building quantum circuits, and at least one measuring device configured to determine states of the processed qubits to generate measurement data. The classical computing system is in communication with the quantum computer and includes a non-transitory memory configured to store specific computer-executable instructions and a hardware processor in communication with the non-transitory memory and the hardware processor is configured to execute the specific computer-executable instructions to at least: receive input data, configure a quantum circuit comprising a time evolution operator approximated using Variational Fast Forwarding (VFF) to generate time evolved quantum states, where the time evolution operator is associated with a Hamiltonian of the quantum system, configure the measuring device to measure a quantum state comprising the time evolved quantum states to determine at least one matrix element of an overlap matrix, and determine the energy of an eigenstate using the at least one matrix element.

According to a ninth aspect a method of operating a quantum computing system for determining an energy of an eigenstate of a quantum system. The quantum computing system includes a quantum computer in communication with a classical computing system and the classical computing system includes a hardware processor. The method is performed by the hardware processor and includes: receiving input data, configuring a quantum circuit comprising a time evolution operator approximated using Variational Fast Forwarding (VFF) to generate time evolved quantum states, wherein the time evolution operator is associated with a Hamiltonian of the quantum system; measuring a quantum state comprising the time evolved quantum states; determining at least one matrix element of an overlap using the measured quantum state; and determining the energy of an eigenstate using the matrix element.

In some embodiments, the quantum system comprises a molecular system and the Hamiltonian is a molecular Hamiltonian. In some embodiments, the time evolution operator comprises WDⁿ W^{†} wherein W is a unitary operator, D is a diagonal operator, and n is a number of evolution time steps. In some embodiments, the time evolved states are approximate time evolved states and are different from exact time evolved states generated using a time evolution operator expressed as exp(—iH□t), where in H is the Hamiltonian of the quantum system. In some examples, the time evolved quantum states (e.g., the approximate time evolved states) are non-orthogonal. In some cases, time evolved quantum states may be generated using multiple time-steps. In some such cases, the multiple evolution time-steps may form a uniform time grid.

According to a tenth aspect, there is provided a transitory computer-readable storage medium comprising specific computer-readable instructions executable on data processing hardware, wherein the specific computer-readable instructions, when executed the data processing hardware, implement the method of the fourth, sixth, or ninth aspect.

In various implementations, computing or determining an energy of an eigenstate of a quantum system (e.g., a molecule) comprises computing eigen values or energy levels of the quantum system. In some examples, the eigen value of the quantum system comprises an energy of a ground state of a molecule.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and apparatus disclosed herein. Moreover, those in the art will understand that the drawings are not to scale. Wherever possible, like elements have been indicated by identical numbers.

Embodiments of the present disclosure will now be described, by way of example only, with reference to the following patent diagrams:

FIG. 1 is a block diagram of a quantum computing system including a classical computing apparatus coupled to a quantum computing apparatus for execute computational tasks.

FIG. 2 illustrates of a quantum phase estimation (QPE) circuit for execution on the quantum computing system of FIG. 1.

FIG. 3 illustrates a controlled Pauli gadget for

$$\text{?}$$

$$\text{?} \text{indicates text missing or illegible when filed}$$

used in a quantum circuit for propagating quantum states in time domain.

FIG. 4 illustrates an example quantum measurement circuit for computing a matrix element of an overlap matrix.

FIG. 5A is a graph of an H₂ binding curve in a STO-3G basis obtained from shot-based variational quantum phase estimation (VQPE) simulations using N_{T}=10 and varying sizes of time grid.

FIG. 5B is a graph of an H₂ binding curve in a STO-3G basis obtained from shot-based variational quantum phase estimation (VQPE) simulations using □t=0.5 and varying numbers of basis states.

FIG. 6A is a graph depicting an H₃⁺ energy in the STO-3G basis obtained from shot-based VQPE simulations using NT=10 and varying sizes of time grid.

FIG. 6B is a graph depicting an H₃⁺ energy in the STO-3G basis obtained from shot-based VQPE simulations using □t=1.0 and varying numbers of basis states (see bottom graph).

FIG. 7 is a graph depicting an H₆ energy in the STO-3G basis obtained using □t=0.5 and varying numbers of basis states; at r_{HH}=0.5, wherein results shown are shifted by 2□ from those directly obtained from using a complex logarithm.

FIG. 8 is a graph illustrating a dependence of the number of linearly independent states (shown as solid lines) and an error in a total energy (shown as dashed lines) on the number of time-evolved basis states for a state-vector simulation and a circuit-based Trotterized time-evolution of H₆ at r_{HH}=2.0 Angstroms, using □t=0.5.sq.

FIG. 9 is a block diagram illustrating the computational steps for computing the matrices used in a generalized eigenvalue equation using Suzuki-Trotter approximation or variational fast forwarding (VFF) method.

FIG. 10 is a depiction of a controlled time evolution operator that is compiled using variational fast forwarding (VFF) and number-conserving gates.

FIGS. 11A-11C depict computational results for VFF-based VQPE with U=0.5, fitted to a single time-step, for Δt ∈{(0.05, 0.1, 0.5, 1.0}. including: calculated overlap between a k-th VFF state and a corresponding time-evolved state (A), the value of the VPQE energy (B) and the number of linearly independent states (C).

FIGS. 12A-12C illustrate results for VFF-based VQPE with U=0.5, fitted to two time-steps for Δt ∈{0.05, 0.1, 0.5, 1.0}. including: overlap between the k-th VFF state and the corresponding time-evolved state, the of the VQPE energy (B), and the number of linearly independent states (C).

FIGS. 13A-13C illustrate results for VFF-based VQPE with U=0.5, fitted to two time-steps, for Δt ∈{0.05, 0.1, 0.5, 1.0}, using a shot-based quantum circuit simulator. The results include: the overlap between the k-th VFF state and the corresponding time-evolved state (A), the value of the VQPE energy (B), and the number of linearly independent states (C).

FIGS. 14A-14C illustrate results for VFF-based VQPE for H₂, fitted to two time-steps, for Δt ∈{0.05, 0.1, 0.5, 1.0}, using a shot-based quantum circuit simulator. The results include: the overlap between the k-th VFF state and the corresponding time-evolved state (A), the value of the VQPE energy (B), and the number of linearly independent states (C).

FIGS. 15A-15C illustrate results for VFF-based VQPE for H₂, fitted to two time-steps, for Δt ∈{0.05, 0.1, 0.5, 1.0}: using a shot-based quantum circuit simulator. The results include: the overlap between the k-th VFF state and a corresponding time-evolved state (A), the value of the VQPE energy (B), the number of linearly independent states (C).

FIG. 16 is a flow chart of steps of a method pursuant to the present disclosure.

FIG. 17 is a flow chart of steps of another method pursuant to the present disclosure.

FIG. 18 is a block diagram illustrating an example quantum computing system.

FIG. 19 is a block diagram illustrating another example quantum computing system.

FIG. 20 is a block diagram illustrating another example quantum computing system.

In the accompanying diagrams, an underlined number is employed to represent an item over which the underlined number is positioned or an item to which the underlined number is adjacent. When a number is non-underlined and accompanied by an associated arrow, the non-underlined number is used to identify a general item at which the arrow is pointing.

### DETAILED DESCRIPTION

### Introduction and Problem Statement

Quantum computers have enabled a paradigm shift in computer technology by exploiting quantum phenomena such as superposition and entanglement that not only increase the computation speed compared to classical computers, but also can provide solutions to computationally complex problems that cannot be solved by classical computers, at least within timeframes suitable for practical applications. Quantum computing algorithms can be executed on quantum computers that use variety of platforms and physical phenomena to implement quantum operation and quantum data. In general, quantum computers and quantum computing systems exploit the quantum nature of fields and particles to solve a complex problem significantly faster than their classical counterparts. In classical processing of data, the data to be processed and the number of classical operations needed to process the data can be very large. For example, computing the energy eigen states of even simple molecules may be intractable or, in some cases, impossible using classical computers. Even the most advanced classical computing systems available today may not be able to determine the energy states of molecular systems within reasonable processing time. By exploiting quantum phenomena, a quantum computer is potentially capable of being configured to process large quantities of data in a highly efficient manner that is unparalleled in classical domain. However, a challenging technical problem in contemporary quantum computation is how to configure quantum computers in a most optimal manner to implement such data processing. Contemporary quantum computing computers that are limited by the number of qubits and quantum gates and the level noise generated are referred to as noisy intermediate scale quantum (NISQ) computers. For example, given number of quantum gates and a level of noise generated by different elements (e.g., quantum gates) of a quantum circuit, how the quantum computer should be used to perform a computational task to solve is a technical problem, such that the noise generated during the computations does not impose a limit on the minimum computational error that can be achieved. To make the most of current NISQ computers, a quantum algorithm should take into account the amount of noise generated in quantum computing operations used to solve a problem.

To limit the usage of quantum computational resources, NISQ computers may be configured to execute hybrid quantum-classical algorithms such as using a combination of a classical computer and a quantum computer when seeking to solve extremely complex problems; in the present disclosure, such a combination will be referred to as a quantum computing system. When tackling a given computing task, the task can be divided between execution on the classical computer and execution on the quantum computer. Moreover, for certain tasks, the classical computer will be more efficient than the quantum computer for handling simple computational tasks, whereas the quantum computer can potentially solve certain types of computation tasks that would be inefficient to perform on the classical computer. However, transferring tasks between the classical computer and the quantum computer has temporal overhead that is preferably reduced as much as possible in order to achieve an optimal computing performance for the quantum computing system.

When using such a tandem configuration of a classical computer and quantum computer, it is sometimes convenient, for example to enhance data processing throughput, to perform certain arithmetic computations on the quantum computer rather than on the classical computer. As mentioned above, a technical problem that arises therefrom is how to configure a quantum computer most effectively for performing certain types of arithmetic computations in a manner that the noise generated during the quantum computation does not impose a constraint on a total number of quantum operations that can be performed for a quantum computational task. Thus, some embodiments of the present disclosure are concerned with addressing a technical problem of configuring a classical computing system coupled in tandem with quantum computer in a manner to provides for more efficient computation of input data to generate corresponding processed output data, and also to reduce a computational error of the processed output data while keeping the quantum noise arising in the quantum computer below a threshold value.

Obtaining energy eigenstates of a quantum system (e.g., a molecule) arises in many applications including in quantum chemistry. In particular ground states (lowest energy states) contain very useful information about a quantum system in general and a molecule in particular. However, finding the ground state and first few excited states can be a complex problem that may not be solved using only classical computers. A variational quantum eigensolver (VQE) consists of a combination of quantum and classical algorithms. The length of the quantum circuit used in a quantum portion of a VQE algorithm may be short enough for implementation in a NISQ computer.

VQE has found use in quantum chemistry simulation applications [3, 4], where an aim is to compute estimates of lowest eigenvalue(s) of a molecular Hamiltonian. Alternative hybrid approaches have also been developed to compute estimates of lowest Eigenvalue(s) of a molecular Hamiltonian based on an imaginary-time evolution of a system [5] and, more recently, based on real-time evolution. When such VQE algorithms are used, a cost function is calculated and then minimized using a classical optimization procedure on classical computer, with an aim to reduce an amount of quantum computation required to an amount that is manageable on the quantum computer, within the constraints of noisy gates and qubits with low coherence times.

Quantum Phase Estimation (QPE) is another algorithm that may be used to estimate energy eigen states for molecular systems. QPE uses a repeated application of a unitary and a quantum Fourier transform to estimate a phase of a unitary operator. QPE has been previously implemented on a real-time evolution operator to compute a lowest eigenvalue of a Hamiltonian. However, QPE has quantum resource requirements that make it intractable on NISQ devices.

A related algorithm is Variational Quantum Phase Estimation VQPE) algorithm [9] that uses time-evolved states as a basis for investigating non-orthogonal configuration interaction (NOCI). NOCI matrix elements are computed on a quantum computer, while the diagonalization is carried out on a classical computer. It has been shown that only relatively few states and a linear number of measurements are needed for NOCI.

VQPE algorithm is part of a wider class of quantum subspace diagonalisation (QSD) methods in which non-orthogonal states are used as a basis to solve a generalised Hamiltonian Eigenvalue problem, providing as a result of quantum computations estimates for multiple Eigenstates. Many of this wider class of methods, including VQPE, perform a diagonalization in a Krylov subspace that is obtained by repeatedly applying some unitary. A subspace diagonalization algorithm may classically diagonalize small matrices, whose elements can be efficiently obtained by a quantum computer.

VQPE algorithm uses a basis of real time-evolved states, for which the energy eigenvalues can be obtained directly from the unitary matrix (e.g., U=e^{-iH□t}) which can be computed with linear cost in the number of states used. A technical problem that arises is that a number of quantum operations (e.g., performed in series) required for generating the time-evolved states, may exceed a limit beyond which a level of noise generated in the quantum circuit may not allow coherent operation of the quantum circuit. This represents a substantial barrier to the application of the VQPE algorithm in this form on NISQ devices. For example, when calculating eigen energy states of molecules, the number of time evolution steps required to generate results with acceptable error may increase superlinearly with a number of atoms in the molecule, making such calculation for multi-atom molecules difficult if not impossible using NISQ devices.

Thus an improved method for generating a quantum-circuit-based implementation of the VQPE algorithm for general molecular Hamiltonians is required, where quantum computing hardware requirements and number of quantum operations performed for implementing such a method are an important consideration. Moreover, a further technical problem that arises is providing a modified VQPE method that reduces the depth of the quantum circuits used to implement VQPE.

Some of the methods and systems disclosed herein provide a circuit-based implementation of VQPE for arbitrary molecular systems. As examples, performance of such circuit-based implementation of VQPE are examined and evaluated for H₂, H₃ and H₆ molecules. Additionally, Variational Fast Forwarding (VFF) is proposed to approximate a time-evolution and decrease the quantum depth of time-evolution circuits for use in VQPE. Such approximation appears to provide a good basis for Hamiltonian diagonalization even when its fidelity to the true time evolved states is low. When fidelity to the true time evolved states is high the linear cost of exact VQPE can be preserved by diagonalizing an approximate unitary matrix instead of the Hamiltonian.

### Quantum Computation System

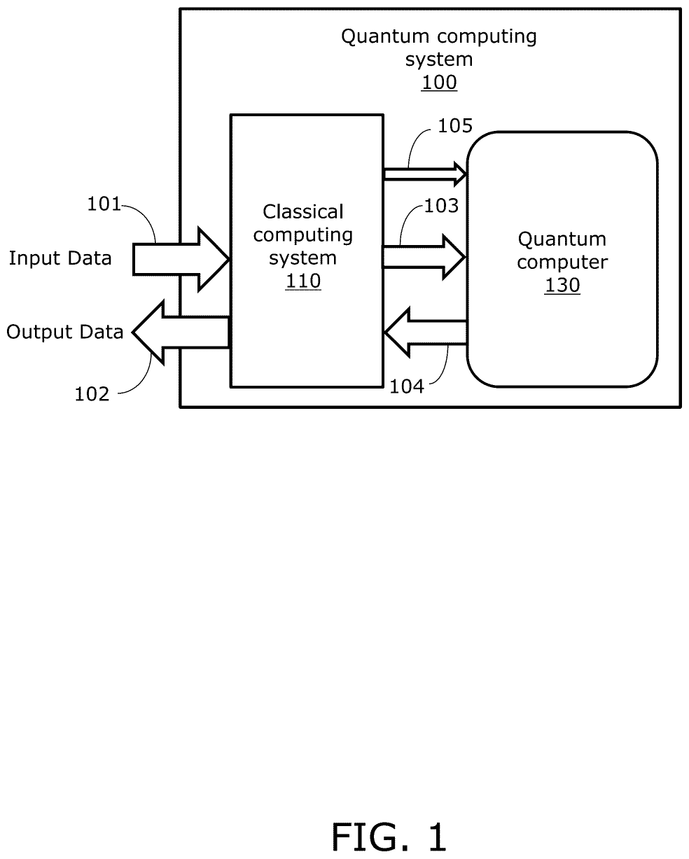

In FIG. 1, there is shown a schematic diagram of a quantum computing system 100. In some examples, the quantum computing system 100 may receive input data 101 from a data source and generate output data 102. In some cases, the input data 101 may comprise a real valued function and the output data 102 may comprise an expectation value of the real valued function with respect to a probability distribution. In some embodiments, the output data 102 may comprise an estimated quantum amplitude having an error below a threshold error. In some implementations, the quantum computing system 100 may include at least a classical computing system 110 (also referred to as being a classical computer or binary data computer) and a quantum computer 130 in communication with the binary data computer. In some cases, the classical computing system 110 may be in communication with the quantum computer 130. In some examples, the classical computing system 110 may be coupled in combination with the quantum computer 130. The classical computing system 110 may exchange data with the quantum computer 130 via one or more data links; the data links may, for example, be provided via use of a data highway. In some examples, the classical computing system 110 may comprise a non-transitory memory and at least one electronic processor configured to execute computer-executable instructions (e.g., software instructions, or program instructions) stored in the non-transitory memory. In some examples, the electronic processor may be implemented using Silicon integrated circuits that perform binary digital computations when is use. The one or more data processors can be configured to execute software instructions for processing the input data 101 to generate the output data 102 with assistance from a quantum computer 130 that is coupled to the classical computing system 110.

The memory may be a non-volatile memory, such as flash memory, a hard disk, magnetic disk memory, optical disk memory, or any other type of non-volatile memory. Furthermore, types of memory may include but are not limited to random access memory (“RAM”) and read-only memory (“ROM”). In some examples, the classical computing system 110 can be programmed to perform different procedures each implemented based on a different set of instructions.

In some cases, the electronic processor of the classical computing system 110 may execute the computer-executable instructions to receive input data 101 from a data source (e.g., from a sensor or a sensor network), to process the input data 101 to generate quantum computer input data 103, and to transmit the quantum computer input data 103 to the quantum computer 130. Additionally, the electronic processor of the classical computing system 110 may send configuration data 105 that is usable for configuring the quantum computer 130 (e.g., for configuring one or more quantum gates of the quantum computer 130). In some cases, the configuration data 105 may be stored in a memory of the classical computing system 110. In some other cases, electronic processing of the classical computing system 110 may generate configuration data 105 based at least in part on the data stored in a memory of the classical computing system 110. In some cases, the configuration data 105 may be provided by a user via a user interface (e.g., a user interface of the classical computing system 110).

In some examples, quantum computer input data 103 may include optional data pertaining to instructions that may be executed or used by a controller of the quantum computer 130 to control and manage certain operational aspects of the quantum computer 130. In some examples, the optional data included in the quantum computer input data 103 may comprise instructions usable by a compiler (e.g., a quantum compiler) that is executed by the controller of the quantum computer 130, for example, to mitigate errors, and managing qubit placement.

In some cases, the data source includes, for example, one or more of: a data memory with data stored therein, a sensor arrangement that is configured to stream sensor data, a user interface. In some embodiments, the data memory source may include an electronic memory configured to store computer-executable data. The data may include, data received from a user, another computing system (e.g., classical or quantum computing system), or a sensor. In some examples, the sensor arrangement includes sensors generating sensor data in real-time, satellite streamed data, camera surveillance systems, genomic data PCR readout machines, MRI 3-D imaging machines, encryption devices and so forth. Alternatively or additionally, the input data 101 may be provided from other sources, for example financial trading data, parameters of physical systems to be modelled, and so forth.

The quantum computer 130 is used by the classical computing system 110 to perform particularly computationally complex tasks that would take the classical computing system 110 an unacceptably long period of time to process. The quantum computer 130 may comprise one or more quantum circuits acting on qubits configured to perform certain computationally complex tasks using quantum effects. In various implementations, the quantum computer 130 may include one or more qubits (e.g., an array of qubits) and one or more quantum gates. In some cases, the quantum gates may comprise one or more rotation gates. In some cases, the quantum circuits may comprise at least a portion of the one or more qubits and one or more quantum gates.

In some implementations, the quantum computer 130 includes in a range of 30 to 1000 qubits, more optionally in a range of 50 to 500 qubits, and various gates that enable quantum parameters such as qubit phase to be modified (namely, rotation operations R) as well as entanglement and superposition operations between qubits to be performed. In some examples, the quantum computer 130 is configured to perform quantum noise reduction to reduce quantum computational errors arising therein. Moreover, in certain configurations of the quantum computer 130, its qubits and quantum gates are cooled to cryogenic temperatures when in operation, for example to within 20 Kelvin or even within 1 Kelvin of absolute zero temperature. Optionally, the quantum computer 130 is implemented using photonic devices, cryogenic superconducting gates or ion traps, or a combination thereof. Optionally, the classical computing system 110 is spatially remote from the quantum computer 130, and data exchange occurs therebetween via one or more data communication links, for example an Internet data link.

In some implementation, the quantum computing system 100, may be configured to execute computer-executable instructions (e.g., program instructions) to process input data 101 to generate corresponding output data 102. The computer executable instructions may be executed by one or more electronic hardware processors of the quantum computing system 100. In some cases, the one or more electronic hardware processors can be electronic hardware processors of the classical computing system 110.

In some cases, the program instructions can include a quantum amplitude estimation and/or amplification algorithms (e.g., maximum likelihood amplitude estimation algorithm), a variational approximation algorithm. In some cases, at least a portion of the quantum amplitude estimation and/or amplification algorithm and the variational approximation algorithm may be executed by the quantum computer 130 using one or more quantum circuits. In some examples, one or more quantum circuits of the quantum computing system may be configured based at least in part the input data 101. The quantum computer 130 may further process the outputs 104 received from the one or more quantum circuits to generate results usable for generating output data 102.

In some implementations, the quantum computer 130 may operate by processing a sequence of “shots”. In some cases, initial states may be defined (Ansatz) and each shot may include, preparing qubits having the defined initial state and performing a temporal sequence of quantum operations on the qubits to generate processed qubits having final states. In some cases, the initial states may comprise ground states (e.g. the lowest energy state of a system, in the absence of excitation operations). In some cases, the quantum computer 130 may generate the processed qubits having the final states by altering the initial states. In some cases, the quantum computer 130 may readout the final state of the processed qubits using measurement operations (e.g., quantum measurement operations).

In some implementations, the quantum computer 130 may include one or more quantum circuits configured to process qubits. In some cases, a number of quantum operations performed by quantum circuit and/or the longest path in the quantum circuit may be referred to as “quantum circuit depth”. In some cases, a path in the quantum circuit may comprise a sequence of quantum operations performed to transform the initial quantum states to the final quantum states.

Each shot may have a temporal duration that, in some cases, can be limited by quantum noise arising in the qubits, wherein the quantum noise can be manifest as qubit decoherence. In some examples, quantum noise arising in qubits increases as more quantum operations are performed on the qubits. As such, the quantum noise may increase with the corresponding quantum circuit depth. Despite such technological challenges, for certain types of computational tasks, the quantum computer 130 is extremely effective. Some of the methods disclosed herein may reduce the quantum circuit depth of the quantum circuits configured to generate outputs usable for computing a value of an arithmetic function based on values of one or more random variables associated with a probability distribution (e.g., a marginal distribution). Advantageously, these methods may reduce the quantum circuit depth without significantly increasing the computation time (e.g., a convergence time) and/or an error associated with the computed value.

In some cases, the configuration data 105 can be generated during execution of the aforesaid software instructions prior to run-time of quantum computer 130. In some examples, the configuration data 105 may include data usable for configuring one or more quantum circuits of the quantum computer 130 based at least in part on an arithmetic function. In some such cases, at least a portion of the software instructions may include a special compiler that upon execution generates the configuration data 105 by compiling another portion of instructions (e.g., configuration instructions), representing a configuration of the quantum computer 130. In some examples, the configuration data 105 may comprise data and/or instructions executable by the quantum computer 130 to configure the quantum circuits therein according to the configuration instructions.

For example, the TKET compiler, provided by Cambridge Quantum Computing Ltd., can convert a portion of the instructions into Hamiltonian functions that are subsequently processed during compilation to generate Pauli strings from which corresponding Pauli gadgets are derived, wherein the Pauli gadgets are then used to define configuration connections for quantum gates of the quantum computer 130, for example thereby creating a given quantum circuit. Such a process of converting Hamiltonian functions eventually to configuration connections for quantum gates is, for example, described in an IBM publication “Circuit optimization of Hamiltonian simulation by simultaneous diagonalization of Pauli clusters”, Ewout van den Berg and Kristan Temme, IBM T. J. Watson, Yorktown Height, NY, USA, 31 Mar. 2020. The entire contents of this IBM publication are incorporated by reference herein and made a part of this specification. Moreover, a publication “A compact ion-trap quantum computing demonstrator”, Pogorelov et al. describes a practical implementation of the quantum computer 130, the entire contents of this publication are incorporated by reference herein and made a part of this specification.

In some cases, a quantum compiler may convert a first quantum circuit or a symbolic form of a first quantum circuit to a second quantum circuit or a symbolic form of a second quantum circuit, wherein the second quantum circuit or the symbolic form of the second quantum circuit comprise ‘native gates’ for the target hardware. In implementations, the TKET compiler may reduce the corresponding quantum circuit depth (e.g., the quantum circuit depth of the second quantum circuit or its symbolic form). In some examples, the TKET compiler may reduce the quantum circuit depth by at least removing some manifest redundancies in the quantum circuit.

It will be appreciated that the aforesaid software instructions can relate to a plurality of types of computation that process data in manner to generate a technical effect, for example for implementing data encryption, data decryption, for filtering measurement data representative of measured physical parameters to reduce stochastic noise in the data, correlating measurement data to detect occurrence of a signal feature that is masked by stochastic noise and so forth. The quantum computing system 100 is thereby capable of providing a technical effect when processing data.

In some applications, computation may require an arithmetic function to be computed. In some cases, it is desirable that arithmetic computations are performed on the quantum computer 130 (e.g., to reduce the computation time). When reading out the aforesaid qubits, various methods can be used to reduce readout noise of the qubits; such methods include quantum amplitude estimation (QAE) requiring shots to be repeated to enable an average of output to be computed from which a best estimate of qubit value can be calculated. For achieving an optimal data processing throughput of the quantum computing system 100, it is often advantageous to reduce an amount of switching of tasks between the quantum computer 130 and the classical computing system 110.

Thus, from the foregoing, it will be appreciated that, in order to obtain a maximum performance from the quantum computing system 100, it is desirable that some of the aforesaid shots enable arithmetic computations to be performed on the quantum computer 130 in preference to using the classical computing system 110. In the present disclosure, there is provided an especially effective and efficient method of implementing such arithmetic computations using the quantum computer 130.

The quantum computing system may include a control system that is coupled to an array of qubits. The array of qubits may be implemented, for example, using ion traps, Josephson junctions, photonic circuits (e.g., implemented on a silicon photonic chip), microwave circuits and the like. The control system may be coupled to a configuration device that is configured to set initial states of the array of qubits and configure the quantum circuits. Moreover, the control system may be coupled to a process control device that is configured to apply a sequence of quantum operations to the array of qubits using the quantum circuits. Furthermore, the control system is coupled to a measuring device that is configured to sense and measure quantum states of the array of qubits after the sequence of quantum operations have been applied to the array of qubits. The measuring device may generate measurement data comprising the outcomes of quantum measurements performed on processed qubits. In some cases, the control system may receive the measurement data and send control signals to the configuration device and the process control device, for example, to configure the array of qubits and a quantum circuit for a next quantum processing step (e.g., a step of an iterative computational process). In some embodiments, the control system, the configuration device, and the process control device are included in a classical computing system 110 and the array of qubits, the quantum circuit, and the measuring device are included in the quantum computer 130. In some such embodiments, the configuration device and the process control device may be included in the quantum computer 130 or the classical computing system 110.

The quantum computing system 100 may be configured to implement variational quantum phase estimation (VQPE). In some implementation, the quantum computing system 100 may be configured to implement variational quantum phase estimation (VQPE) combined with variational fast forwarding (VFF) algorithm, using fixed depth quantum circuit arrangements. In embodiments of the present disclosure, it is feasible to calculate the energy eigen states of complex quantum systems (e.g., molecules) based on VQPE combined with VFF and using a NISQ computing system.

In embodiments of the present disclosure, exponential noise accumulation in the array of qubits of the quantum computing system is suppressed; in general, the exponential noise accumulation increases in magnitude as the depth of the quantum circuit is increased. Embodiments of the present disclosure beneficially use fixed-depth quantum circuits that have a fixed depth, wherein the fixed-depth quantum circuits can be fine-tuned based on characteristics of quantum hardware of the quantum computing system. Thus, it is feasible to implement optimal hardware operations in the quantum computing system 100 that are susceptible to achieve a theoretical speed-up when calculating the energy of the eigenstates of a Hamiltonian (e.g., a chemical Hamiltonian representing a molecule). Such a benefit may be achieved by using a variational fast forwarding (VFF) method when generating time-evolved quantum states for diagonalizing the Hamiltonian or another operator derived from the Hamiltonian.

In embodiments of the present disclosure, a level of quantum noise arising in quantum hardware of the quantum computing system during a computational task (e.g., quantum amplitude estimation or amplification) may be reduced by using computational steps that allow performing the computational task while maintaining the depth of the corresponding quantum circuits constant. Moreover, in the embodiments, there is used a learning strategy that mitigates sub-optimal qubit control, wherein quantum noise otherwise grows exponentially as function of quantum circuit depth, wherein the quantum noise can potentially cause decoherence of the array of qubits, namely potentially a complete loss of quantum properties of the array of qubits.

### Detail Description of Embodiments

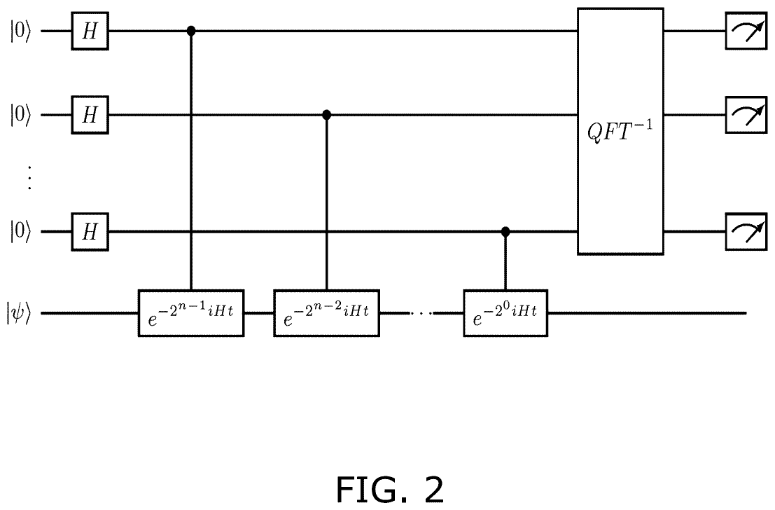

As background, to assist understanding of embodiments of the present disclosure, an overview of quantum phase estimation (QPE) algorithm will be provided. Given a unitary operator Û and one of its eigenfunctions |Φ [symbol] such that Û|Φ [symbol] =∈^{12πU}|Φ [symbol] , QPE can be used to estimate a value of □. For a Hermitian Hamiltonian denoted by Ĥ, a corresponding time-evolution operator Û=e^{-iHt} is unitary and may be used in QPE, using a quantum circuit as given in FIG. 2 that is susceptible to being executed using the quantum computing system 100. Before an inverse quantum Fourier transform (QFT), a generated wavefunction is given by

$$\vert {Ψ}_{QPE} 〉 = \frac{1}{{2}^{n / 2}} {\sum }_{j = 0}^{{2}^{n} - 1} {e}^{- i \hat{H} tj} \vert j 〉 \vert ψ 〉 . \qquad ( 1 )$$

wherein |j [symbol] is a qubit product state corresponding to a binary encoding of j. Taking the inverse quantum Fourier transform (QFT) gives

$${QFT}^{- 1} [ \vert {Ψ}_{QPE} 〉 ] = \frac{1}{{2}^{n / 2}} {\sum }_{k = 0}^{{2}^{n} - 1} \vert k 〉 ( {\sum }_{j = 0}^{{2}^{n} - 1} {e}^{- itj ( {ω}_{k} + \hat{H} )} \vert ψ 〉 ) \qquad ( 2 )$$

wherein ωₖ=2πk/(2ⁿt). If |Φ is an eigne function of Ĥ then

$$\hat{H} \vert ψ 〉 = E \vert ψ 〉 , \qquad ( 3 )$$

wherein this reduces to

$${QFT}^{- 1} [ \vert {Ψ}_{QPE} 〉 ] = \frac{1}{{2}^{n / 2}} {\sum }_{k = 0}^{{2}^{n} - 1} \vert k 〉 ( {\sum }_{j = 0}^{{2}^{n} - 1} {e}^{- itj ( {ω}_{k} + E )} \vert ψ 〉 ) , \qquad ( 4 )$$

which peaks around ωₖ=−E, so measurement is highly likely to give an n-bit integer approximation of k=−2ⁿtE/2π.

Provided a guess wavefunction |\tilde{Φ}>, QPE will successfully generate an eigenvalue E with a probability proportional to | [symbol] \tilde{Φ}|Φ [symbol] |². As such, if one has access to a wavefunction with good overlap with the ground state of a quantum system, QPE can be used to estimate a true ground state energy with a high probability for certainty. For quantum chemical systems simulated using the quantum computing system 100, a Hartree-Fock (HF) wavefunction may often be good enough, but techniques such as adiabatic state preparation [18, 19] may be used to improve upon it.

### Variational Quantum Phase Estimation (VQPE)

Next, a more advanced form of quantum phase estimation (QPE), namely variational quantum phase estimation (VQPE) will be described in overview. VQPE requires a reference state with some non-zero overlap with an eigenbasis of a Hamiltonian. It is possible to expand the reference state |Φ₀ [symbol] in terms of the eigenfunctions |N [symbol] as

$$\vert {Φ}_{0} 〉 = {\sum }_{N}^{Q} {ϕ}_{N}^{0} \vert N 〉 , \qquad ( 5 )$$

wherein ϕ_{N}⁰=(N|Φ₀). A key step in VQPE is to define a series of time-evolved states If |Φ_{j,0}

[symbol]

$$\vert {Φ}_{j , 0} 〉 = {e}^{- i \hat{H} {t}_{j}} \vert {Φ}_{0} 〉 , \qquad ( 6 )$$

which can also be expanded on an eigenbasis of Ĥ as

$$\vert {Φ}_{j , 0} 〉 = {\sum }_{N}^{Q} {ϕ}_{N}^{0} {e}^{- {iE}_{N} {t}_{j}} \vert N 〉 . \qquad ( 7 )$$

Such time-evolved states form a Krylov subspace which are susceptible to being used as a basis for configuration interaction (CI) or exact diagonalization (ED) [20, 21]. Consider a wave-function

$$\vert Ψ 〉 = {\sum }_{j = 0}^{{N}_{T}} {c}_{j} \vert {Φ}_{j , 0} 〉 . \qquad ( 8 )$$

Minimising <E> with respect of all cⱼ for this wavefunction according to the variational principle is equivalent to solving a generalized eigenvalue problem as follows:

$$Hc = ϵ Sc . \qquad ( 9 )$$

wherein the elements of the matrices H and S are given by

$${H}_{jk} = 〈 {Φ}_{j , 0} \vert \hat{H} \vert {Φ}_{k , 0} 〉 \qquad ( 10 )$$

$$and$$

$${S}_{jk} = 〈 {Φ}_{j , 0} \vert {Φ}_{k , 0} 〉 = 〈 {Φ}_{0} \vert {e}^{- i \hat{H} ( {t}_{k} - {t}_{j} )} ) \vert {Φ}_{0} 〉 \qquad ( 11 )$$

respectively. Solving this matrix equation gives approximate values for N_{T}+1 eigenvalues of Ĥ.

Consider an overlap operator

$$\begin{matrix}\hat{S} & = {\sum }_{j = 0}^{{N}_{T}} \vert {Φ}_{j , 0} 〉 〈 {Φ}_{j , 0} \vert \\ & = {\sum }_{N , M}^{Q} {ϕ}_{N}^{0} {ϕ}_{M}^{0 *} [ {\sum }_{j = 0}^{{N}_{T}} {e}^{- {it}_{j} ( {E}_{N} - {E}_{M} )} ] \vert N 〉 〈 M \vert\end{matrix} . \qquad ( 12 )$$

In an original work by Klymko et al. [9], there is defined a set of phase cancellation conditions,

$$\frac{1}{{N}_{T} + 1} {\sum }_{j = 0}^{{N}_{T}} {e}^{- {it}_{j} ( {E}_{N} - {E}_{M} )} = {δ}_{N , M} \qquad ( 13 )$$

under which

$$\hat{S} = ( {N}_{T} + 1 ) {\sum }_{N}^{Q} {\vert {ϕ}_{N}^{0} \vert}^{2} \vert N 〉 〈 N \vert . \qquad ( 14 )$$

If these conditions are satisfied, then the set of time-evolved states will span a full support space of an initial state and VQPE will be able to recover perfectly all eigenstates in that support space. Such recovery requires at least as many time-evolved states as there are eigenstates in the support space, which may not be tractactable for general systems, for example classical computing systems. However, even an incomplete basis may give a good approximation for a ground state energy of a given system. Additionally, a fact that time-evolution does not introduce any additional eigenstates beyond those present in initial states guarantees beyond those present in the initial states guarantees that a minimum number of basis states is needed to resolve those eigenvectors. For traditional configuration interaction algoithms such as CISD or NOCI, there are no such guarantees in place.

An alternative to Eq. (9) may be defined by considering a time evolution operator Û(Δt)=e^{-iĤΔt}. For eigenfunctions of a Hamiltonian,

$$\hat{U} ( Δ t ) \vert N 〉 = {e}^{- {iE}_{N} Δ t} \vert N 〉 . \qquad ( 15 )$$

Therefore, we can define an alternate generalised eigenvalue problem,

$$U ( Δ t ) c = λ Sc . \qquad ( 16 )$$

Solutions to Eqs. (9) and (16) are related in the same way as corresponding operators, up to a phase factor:

$${ϵ}_{N} = - \frac{log ( {λ}_{N} )}{i Δ t} \pm \frac{2 n π}{Δ t} . \qquad ( 17 )$$

Time evolution matrix elements are given by

$$\begin{matrix}U {( Δ t )}_{jk} & = 〈 {Φ}_{j , 0} \vert {e}^{- i \hat{H} Δ t} \vert {Φ}_{k , 0} 〉 \\ & = 〈 {Φ}_{0} \vert {e}^{- i \hat{H} ( Δ t + {t}_{k} - {t}_{j} )} \vert {Φ}_{0} 〉\end{matrix} . \qquad ( 18 )$$

In a case where a uniform time grid tⱼ=jΔt is used, these coincide with elements of an overlap matrix

$$U {( Δ t )}_{j , k} = {S}_{j , k + 1} = {S}_{j - 1 , k} . \qquad ( 19 )$$

Therefore, while Eq. (9) requires separate measurements of all Hamiltonian and overlap matrix elements, for Eq. (16) there is required to measure elements of the overlap matrix to obtain both U and S. Furthermore, in a uniform time grid case

$$\begin{matrix}{S}_{jk} & = 〈 {Φ}_{0} \vert {e}^{- i \hat{H} ( {t}_{k} - {t}_{j} )} \vert {Φ}_{0} 〉 \\ & = 〈 {Φ}_{0} \vert {e}^{- i \hat{H} Δ t ( k - j )} \vert {Φ}_{0} 〉 \\ & = {S}_{j + n , k + n} , ∀ n ∈ ℤ\end{matrix} \qquad ( 20 )$$

Therefore, to construct the full overlap matrix, there is only required to compute one row of elements. Such an approach is a significant advantage to this algorithm, as it reduces the number of measurements to be linear in the number of time-evolved states rather than quadratic. As in direct Hamiltonian diagonalisation, the eigenvalues of Û provide estimates for both the ground and excited states of an associated system, although a presence of phase factors may confuse an identity of the states. Iterative finding the eigenvectors of Û is then susceptible to giving the variationally optimized parameters cⱼ in Eq. (8).

Next, a comparison of VQPE to QPE will be provided. Consider N_{T}=2ⁿ−1 time-evolved states using an evently-spaced time-grid, where n is the number of measurement qubits in a QPE circuit. A QPE wave-function in EQ. (1) can be expressed on this basis as

$$\vert {Ψ}_{QPE} 〉 = \frac{1}{\sqrt{{N}_{T} + 1}} {\sum }_{j = 0}^{{N}_{T}} \vert j 〉 \vert {ϕ}_{j , 0} 〉 . \qquad ( 21 )$$

Similarly, the result of the inverse QFT is given by

$$\begin{matrix}{QFT}^{- 1} [ \vert {Ψ}_{QPE} 〉 ] & = \frac{1}{{N}_{T} + 1} {\sum }_{k = 0}^{{N}_{T}} \vert k 〉 ( {\sum }_{j = 0}^{{N}_{T}} {e}^{i {ω}_{k} {t}_{j}} \vert {ϕ}_{j , 0} 〉 ) \\ & = \frac{1}{\sqrt{{N}_{T} + 1}} {\sum }_{j = 0}^{{N}_{T}} \vert k 〉 \vert {ω}_{k} 〉\end{matrix} . \qquad ( 22 )$$

$$where$$

$$\vert {ω}_{k} 〉 = \frac{1}{\sqrt{{N}_{T} + 1}} {\sum }_{j = 0}^{{N}_{T}} {e}^{i {ω}_{k} {t}_{j}} \vert {ϕ}_{j , 0} 〉 \qquad ( 23 )$$

form a Fourier basis. For the QPE algorithm to give a same estimate of the ground-state energy as exact diagonalisation, the Hamiltonian and overlap matrix must be diagonal on a Fourier basis. Under these circumstances, both QPE and VQPE, which explicitly diagonalise on a basis of time-evolved states, generate the same ground-state energy.

### Circuit Implementation of VQPE

Next, a quantum circuit implementation of VQPE will be described in greater detail. In a second quantization, a chemistry Hamiltonian may be written as

$$\hat{H} = {\sum }_{p , q} {f}_{pq} {\hat{a}}_{p}^{†} {\hat{a}}_{q}^{†} + {\sum }_{p , q , r , s} {h}_{pqrs} {\hat{a}}_{p}^{†} {\hat{a}}_{q}^{†} {\hat{a}}_{r} {\hat{a}}_{s} , \qquad ( 24 )$$

wherein \hat{α}ₚ^{†} and \hat{α}ₚ are fermionic creation and annihiliation operators, respectively. These operators may be mapped onto strings of Pauli operators acting on qubits by a variety of schemes such as Jordan-Wigner or Bravyi-Kitaev encodings. For example, in the Jordan-Wigner mapping:

$${\hat{a}}_{j}^{†} = {⊗}_{i}^{j - 1} {Z}_{i} ⊗ \frac{1}{2} ( {X}_{j} - {iY}_{j} ) , \qquad ( 25 )$$

$${\hat{a}}_{j} = {⊗}_{i}^{j - 1} {Z}_{i} ⊗ \frac{1}{2} ( {X}_{j} + {iY}_{j} ) . \qquad ( 26 )$$

By applying this transformation to all terms in the Hamiltonian, it is feasible to obtain an equivalent qubit Hamiltonian

$$\hat{H} = {\sum }_{k} {\hat{h}}_{k} = {\sum }_{k} {h}_{k} {\overline{P}}_{k} \qquad ( 27 )$$

where \hat{P}ₖ are strings of Pauli operators. It is then feasible to take the first oder Trotter-Suzuki approximation to the time evolution operator, for a finite time step of the whole evolution

$${e}^{- i \hat{H} Δ t} \approx {\prod }_{k} {e}^{- i {\hat{h}}_{k} Δ t} = \hat{U} . \qquad ( 28 )$$

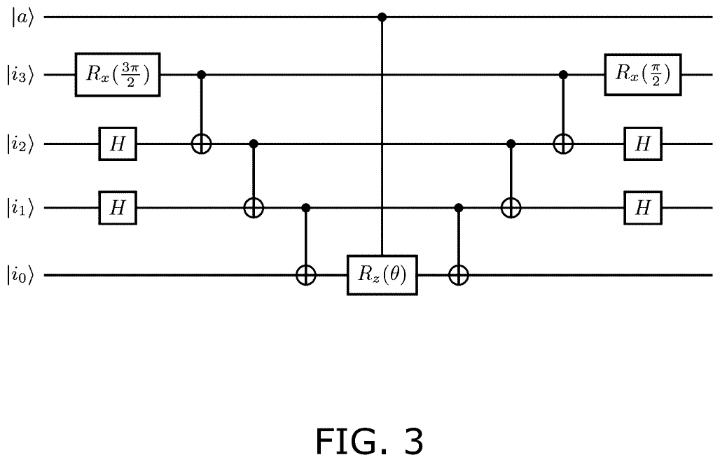

Such a computtion of Eq. (28) is exact in the limit of an infinitely small time step. The Trotterization can be efficiently encoded in a quantum circuit and controlled onto an ancilla, where it is formed from a succession of controlled Pauli gadgets, like those illustrated in FIG. 3.

Propagation by multiple time-steps may be approximated due to a Trotter error by

$$\text{?} \approx \text{?} . \qquad ( 29 )$$

$$\text{?} \text{indicates text missing or illegible when filed}$$

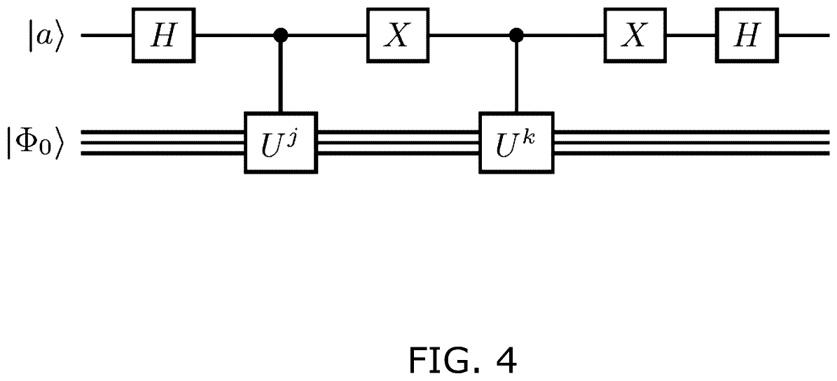

It is thereby feasible to encode |Φ_{j,0}| as

$$\vert {Φ}_{j , 0} 〉 = {\hat{U}}^{j} \vert {Φ}_{0} 〉 \qquad ( 30 )$$

where |Φ₀ [symbol] is chosen to be the Hartree-Fock wavefunction for the system. In order to compute Sⱼₖ, the circuit in FIG. 4 is implemented; FIG. 4 is an illustration of a quantum measurement circuit for Sⱼₖ= [symbol] Φ_{j,0}|Φ_{k,0} [symbol] .

At the end of the circuit in FIG. 4, the qubit register is in a state

$$\vert Ψ 〉 = \frac{1}{2} \vert 0 〉 ( \vert {Φ}_{k , 0} 〉 + \vert {Φ}_{j , 0} 〉 ) + \frac{1}{2} \vert 1 〉 ( \vert {Φ}_{k , 0} 〉 - \vert {Φ}_{j , 0} 〉 ) \qquad ( 31 )$$

and measuring the ancilla in either the Z or Y basis gives the real and imaginary parts of the Sⱼₖ respectively.

$$〈 Ψ \vert {Z}_{a} \vert Ψ 〉 = Re ( 〈 {Φ}_{j , 0} \vert {Φ}_{k , 0} 〉 ) \qquad ( 32 )$$

$$〈 Ψ \vert {Y}_{a} \vert Ψ 〉 = Im ( 〈 {Φ}_{j , 0} \vert {Φ}_{k , 0} 〉 )$$

Additionally,

$$〈 Ψ \vert {Z}_{a} \hat{H} \vert Ψ 〉 = Re ( 〈 {Φ}_{j , 0} \vert \hat{H} \vert {Φ}_{k , 0} 〉 ) \qquad ( 33 )$$

$$〈 Ψ \vert {Y}_{a} \hat{H} \vert Ψ 〉 = Im ( 〈 {Φ}_{j , 0} \vert \hat{H} \vert {Φ}_{k , 0} 〉 )$$

so Hamiltonian elements may be computed using the same circuit if needed.

In the case of Pauli gadgets, it is easy to implement a controlled gadget, as it only requires controlling the central R_{z} gate as can be seen in FIG. 3. For number conserving Û operators, alternative measurement circuits are possible which do not require controlled operations. It will be appreciated that individual Pauli strings in the Trotterized time-evaluation operator are not number preserving, such that these measurement techniques do not perform well in this case. If Eq. (20) holds, there is only a need to compute first row elements of the overlap, S₀ₖ, so the circuit in FIG. 4 simplifies to a Hadamard test.

### Results

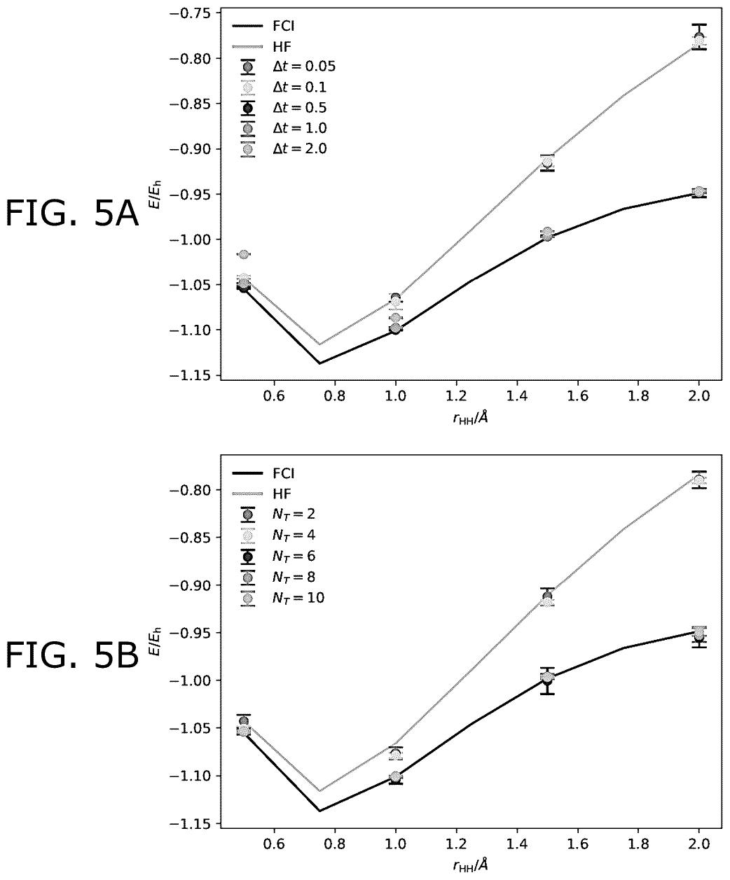

or example, testing this method on H₂, linear H₃⁺ and linear H₆ is feasible using a proprietary Qiskit Aer shot-based quantum simulator and comparing results obtained therefrom by direct matrix algebra on the corresponding state-vectors. Time-evolved states are constructed by repeating the quantum circuit for unitary Û from Eq. (28). An overlap between the initial state |Φ₀> and each time-evolved state is obtained by measuring ancilla as illustrated in FIG. 4, for example using 10000 shots in each case. Optionally, ten (10) different runs are averaged to obtain the final results and error bars illustrated in FIGS. 5A-5B, 6A-6B, and 7. In all cases, there is considered a threshold of 0.1 on the eigenvalues of the overlap matrix to define the number of linearly independent vectors in the space. While lower thresholds could be used for some systems, leading to faster convergence, a large value is more consistent with the high noise that is expected from real hardware, namely NISQ hardware. For state-vector manipulation, the initial state vector is beneficially repeatedly multiplied by the exact matrix corresponding to e^{-tĤΔt} and a much lower linear dependency threshold (10⁻⁵) is beneficially used.

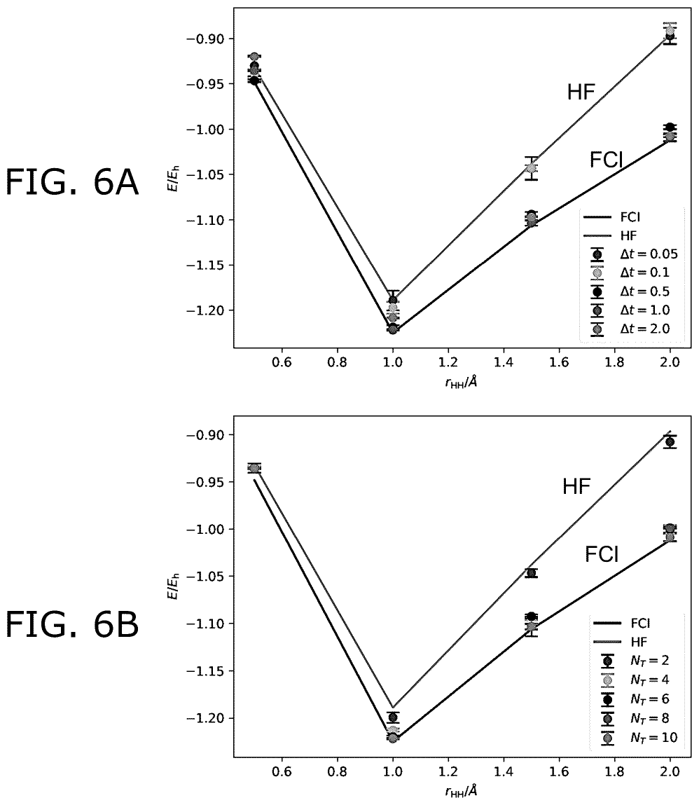

For H₂ and H₃⁺, there is beneficially used a range of time-steps Δt∈{0,06, 0.1, 0.5, 1,0, 2.0} and up to 10 time-steps in each case, for example as illustrated in FIGS. 5A, 5B, 6A, and 6B. FIG. 5A is a graph of an H₂ binding curve in a STO-3G basis obtained from shot-based variational quantum phase estimation (VQPE) simulations using N_{T}=10 and varying sizes of time grid. FIG. 5B is a graph of an H₂ binding curve in a STO-3G basis obtained from shot-based variational quantum phase estimation (VQPE) simulations using □t=0.5 and varying numbers of basis states. FIG. 6A is a graph depicting an H₃⁺ energy in the STO-3G basis obtained from shot-based VQPE simulations using N_{T}=10 and varying sizes of time grid. FIG. 6B is a graph depicting an H₃⁺ energy in the STO-3G basis obtained from shot-based VQPE simulations using □t=1.0 and varying numbers of basis states.

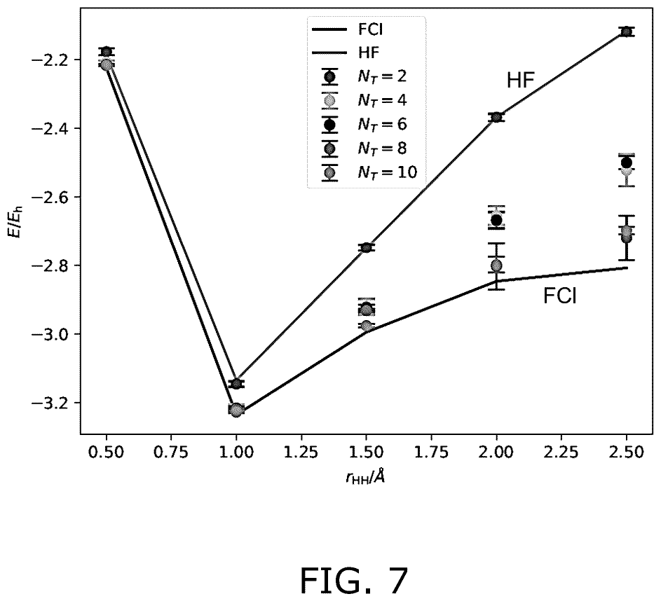

For H₆, it is found that the calculations are significantly more sensitive to the size of the time-step, with many value of □t giving unphysical energies. In FIG. 7, there are shown results obtained using best attempted time-steps. The graph in FIG. 7 depicts an H₆ energy in the STO-3G basis obtained using □t=0.5 and varying numbers of basis states; at r_{HH}=0.5, where results shown are shifted by 2□ from those directly obtained from using a complex logarithm.

A few salient features in these systems is beneficially noted, as follows. Firstly, convergence with increasing number of time-evolved states is not smooth, but occurs in jumps. For example, in FIG. 5B, it is observed that the N_{T}=2 an N_{T}=4 values oscillate around the HF energy while for N_{T}≥6; the energy is converged to the FCI value. For H₆, there is observed a similar, multi-stage process, although in this case the energy is not converged by N_{T}=10 for stretched geometries, for example as illustrated in FIG. 7. Indeed, it is possible for the calculations not to converge at all and merely oscillate around the HF energy if the time-step is too small, as is the case or □t=0.05 and □t=0.1 in the H₂ and H₃⁺ systems. All of these behaviours can be linked to the variation of the number of linearly-independent states in the time-evolved basis. For H₂, the eigenbasis is two-dimensional, so a jump from an HF energy to an FCI is observed when evolution successfully generates a second linearly-independent state. For small □t, ten steps are not enough to surpass a linear dependency threshold, so no change in energy is observed. If the threshold were made lower, the second state may appear after fewer steps, but care needs to be taken to ensure that no spurious states are generated by noise. In a noiseless simulation of the time-evolution evolving by one time step, there is always generated a linearly-independent state and therefore there is recovered the FCI energy regardless of the size of □t.

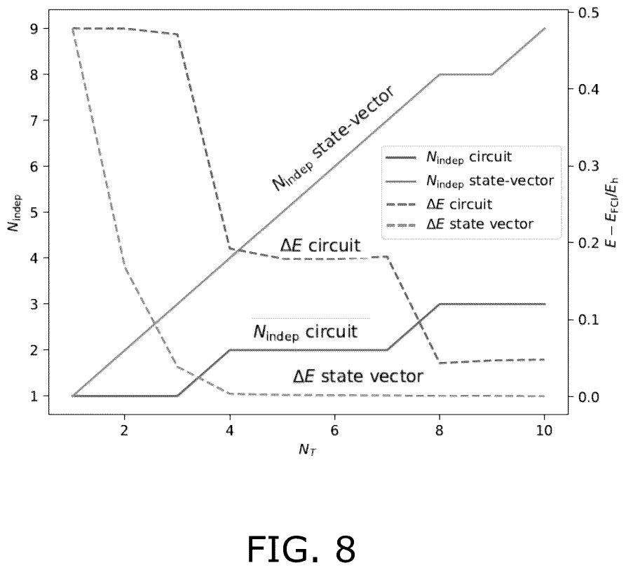

It can be seen in FIG. 8, similar behaviour is observed for the H₆ chain. At □t and r_{HH}=2.0, the simulated state-vector evolution largely introduces one new linearly-independent basis state for each time-evolved state, leading to a fast, exponential convergence to the full CI solution. The circuit-based evolution introduces independent states much more slowly, with energies agreeing with the state-vector values using the same size of basis.

Table I. shows the number of total gates and CNOTs per Trotterised time-evolution step for the H₃⁺ and H₆ systems in the STO-3g basis set.

| System | Gates/step | CNOTs/step |
|---|---|---|
| H₂ | 112 | 34 |
| H₃⁺ | 671 | 300 |
| H₆ | 15713 | 9638 |

Therefore, when using the exact evolution, four time-steps are enough to recover the FCI energy, but significantly more are needed in the circuit-based evolution to get over the increased dependency threshold. This represents a substantial barrier to the application of the VQPE algorithm in this form on NISQ devices.

As can be seen from Table I, the number of gates required to evolve the system one step is large and grows rapidly with system size, quickly exceeding the depth of circuit that can be computed within the coherence time of current NISQ devices. While in this parameterisation, even one step would be challenging to compute, wherein the number of steps could in principle be reduced by increasing the size of t to more quickly surpass the dependency threshold. However, this would have the undesired side-effect of increasing the error associated with the Trotter decomposition of the time-propagation operator.

Approximating VOPE with Variational Fast Forwarding

Next, approximating VQPE with variational fast forwarding (VFF) will be described in greater detail. Faced with the presently intractable increasing depth of time-evolution circuits, potential routes to circumvent this problem have been investigated for devising embodiments of the present disclosure. One approach, which leads to constant depth approximation for time-evolution circuits, is Variational Fast Forwarding (VFF). [16, 17] In this VFF approach, the time-evolution operator is approximated as

$$\text{?} \approx \hat{V} ( θ , γ ) \approx \text{?} ( θ ) \hat{D} ( γ ) \text{?} ( θ ) , \qquad ( 34 )$$

$$\text{?} \text{indicates text missing or illegible when filed}$$

wherein \hat{D} is a diagonal operator and Ŵ is an arbitrary unitary operator. In this case,

$$\text{?} \approx \hat{W} \text{?} . \qquad ( 35 )$$

$$\text{?} \text{indicates text missing or illegible when filed}$$

The diagonal part may be expressed as

$$\text{?} ( γ ; Δ t ) = {\prod }_{m = 0}^{n - 1} \text{?} , \qquad ( 36 )$$

$$\text{?} \text{indicates text missing or illegible when filed}$$

where Sₘ is the set of n-bit binary numbers with m bits set, jₖ is is the value of the k^{th} bit in j and □ is a set of parameters to be variationally optimised. This expression Eq. (36) may be further approximated by truncating m. In this parameterisation,

$$\text{?} ( γ ; Δ t ) = \text{?} ( n γ ; Δ t ) , \qquad ( 37 )$$

$$\text{?} \text{indicates text missing or illegible when filed}$$

making the construction of operators for different values of □t easy and cheap (in terms of quantum circuit implementation).

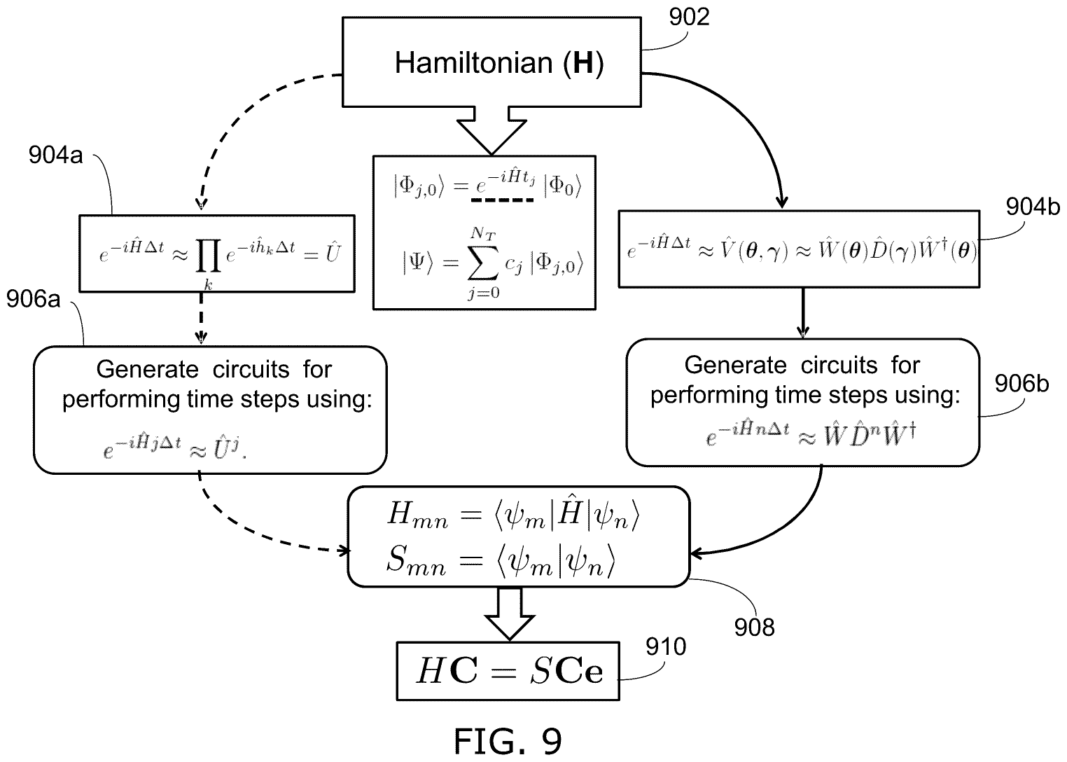

FIG. 9 is a block diagram illustrating the computational steps for computing the elements of the Hamiltonian and the overlap matrices using two different methods: 1) using Suzuki-Trotter approximation to the time evolution operator (described in the section titled Circuit implementation of VQPE, and 2) generating the time-evolved states using variational fast forwarding (VFF) method. In FIG. 9, blocks 902, 904a, 906a, 908, and 910 represent the first method, blocks 902, 904b, 906b, 908, and 910 represent the second method. Both methods use a Hamiltonian 902, whose eigenstates and values are of interest, to determine a time evolution operator for generating time-evolved states that span a subspace (e.g., a Krylov subspace). In some cases, at least the first method may use a reference state (□₀) for generating time-evolved states. The Hamiltonian 902 (e.g., a chemical Hamiltonian representing a molecule) and the reference state can be included or extracted from input data received by the classical computing system 110. In some embodiments, the classical computing system 110 may generate one or both the Hamiltonian and reference state by processing input data. If the first method is used, the classical computing system 110 may generate a Trotter-Suzuki approximation to the time evolution operator 904a for a finite time step (□t). The Trotterized time evolution operator 904a is then encoded in a quantum circuit 904b of the quantum computer 130 that performs the time steps and generates the time-evolved states.

If the second method is used, the classical computing system 110 may generate an approximate time evolution operator 904a of the form WDⁿ W^{†} wherein W is a unitary operator, D is a diagonal operator, and n is a number of evolution time steps. W is a time evolution operator and D is an operator defining a duration of an evolution time step. In some cases, the classical computing system 110 may parametrize W using a symmetry preserving ansatz. The approximate time evolution operator (WDW^{†}) is then encoded in a quantum circuit 904b of the quantum computer 130 that performs the time steps and generates the time-evolved states.

The quantum computer 130, generates the matrix elements 908 of the Hamiltonian (H) and the overlap operator(S) using the time-evolved states. The matrix elements 908 may be used to solve a generalized eigen value equation 910 to generate the output results including the eigen energies and eigen quantum states of the Hamiltonian.

Advantageously, when the second method is used, a depth of the quantum circuit used to generate the time-evolved states may be independent of the number of time steps performed and therefore the depth of quantum circuit remains constant even for more complex quantum systems (e.g., molecules having many atoms) where more time steps are required.

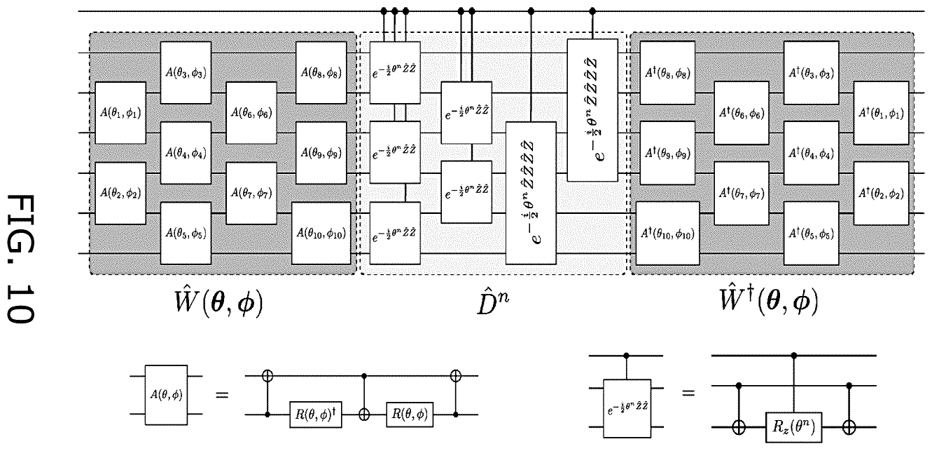

The Ŵ operator can be parameterised in various ways, provided they have enough flexibility to express the required unitary. Different layered ansatz have been used for this. In embodiments of the present disclosure, there are used the symmetry-preserving ansatz. A circuit structure for the controlled time evolution operator can be seen in FIG. 10. This controlled time evolution operator is compiled using variational fast forwarding (VFF) and number-conserving gates; thus, the circuit structure is number-preserving and can also be designed to avoid symmetry and spin contamination. In order to optimise the parameters □ and □, a cost function of the form [17]

$$f ( θ , γ ) = 1 - \frac{1}{n} {\sum }_{k = 1}^{n} \vert 〈 ψ \vert {( {V}^{k} )}^{†} \text{?} \vert ψ 〉 {\vert}^{2} \qquad ( 38 )$$

$$\text{?} \text{indicates text missing or illegible when filed}$$

is minimized. The cost function has a value of 0 when the overlap between the states generated by time-evolution and those generated by repeatedly applying \hat{V} is perfect. Exact time-evolution will preserve the support space of the initial wave function |Φ>, so the unitary \hat{V} must match the action of the time-evolution operator in this space. The “No-Free-Lunch theorem” then dictates that, in order to fully describe the action of the time-evolution unitary on the support space of the initial state, the cost function would require one term for each dimension in this space. This approach is hardly useful if it is desirable to devise a lower-cost alternative to VQPE, as it would require measurements of as many, if not more, overlaps with time-evolved states as the full VQPE approach to obtain and optimise the cost-function, thereby not removing the need for extremely long Trotter circuits.

To overcome this problem, in embodiments of the present disclosure, it is advantageous to relax the condition that the non-orthogonal basis must be constructed from exact time-evolved states. As long as Û commutes with the Hamiltonian. it will share the same eigenfunctions, giving

$$\text{?} \vert {Φ}_{0} 〉 {\sum }_{N} {ϕ}_{N}^{0} \text{?} \vert N 〉 {\sum }_{N} {ϕ}_{N}^{0} {u}_{N} \vert N 〉 . \qquad ( 39 )$$

$$\text{?} \text{indicates text missing or illegible when filed}$$

The repeated application of Û does not change the support space of |Φ₀>, so it could be used instead of the time-evolution operator. Unitary operators that do not commute with the Hamiltonian can also be used to generate basis states for exact diagonalisation. However, they are not guaranteed to maintain the same support space for all states and therefore may require more basis functions to obtain good estimates of the true eigenstates.

For Û≠e^{-tĤΔt}, there is no longer an explicit relationship between the eigenvalues of the Hamiltonian and those of Û, so the former cannot be easily extracted from the diagonalization of Û. If |Û, Ĥ|=0, then the Hamiltonian may be applied to the eigenvectors of Û to obtain the eigenvectors of Ĥ. If [Û, Ĥ]≠0 however, the only option is to construct the Hamiltonian matrix in the basis of states obtained by repeated application of Û and directly diagonalise it. It will also be appreciated that, regardless of the relation of Û with the time-evolution operator, diagonalising this matrix amounts to a Krylov subspace diagonalisation, where the space is given by {|Φ₀ [symbol] , Û|Φ₀ [symbol] , Û²|Φ₀ [symbol] . . . }. Provided enough linearly independent states are considered to span the full support space of this Krylov subspace, the eigenvalues obtained from the diagonalization should be correct. Therefore, it will be appreciated that even a poor VFF approximation to e^{-iĤΔt} is expected to be useable in VQPE and still generate good results, if direct Hamiltonian diagonalization is used.

Next, results obtained by using embodiments of the present disclosure will be described. Examples of methods of the present disclosure are described here for H₂ and 2-electron 2-site Hubbard model, using n=1 or n=2 in Eq. (38). Both of these systems have a 6-dimensional Hilbert space, if both spin projections mₛ=0 and mₛ=1 are taken into account. While the true time-evolution does not couple these subspaces, it is found that the VFF approximation is capable of generating contributions from the mₛ=1 subspace event when starting with an mₛ=0 state. For VFF, it is feasible to generate the first few exact time-evolved states using a state-vector simulation of the Hamiltonian. Moreover, it is also feasible to extract the parameterised state-vector representation of the VFF wave functions from the corresponding circuits and classically compute their overlap and the resulting value of the cost function. Once the VFF parameters are optimised, the overlap and Hamiltonian elements between these states are beneficially obtained either from a shot-based simulation with 50, 000 shots, with linearly dependence threshold of 0.1 for the eigenvalues of S, or from direct matrix algebra on the corresponding state vectors.

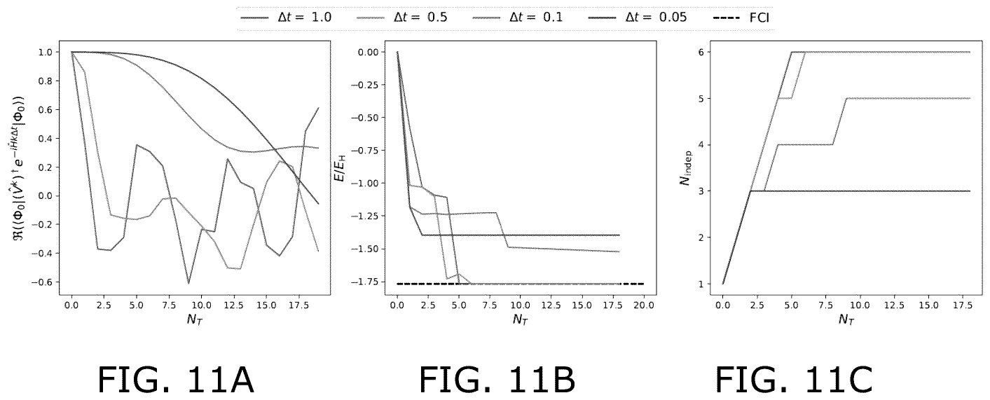

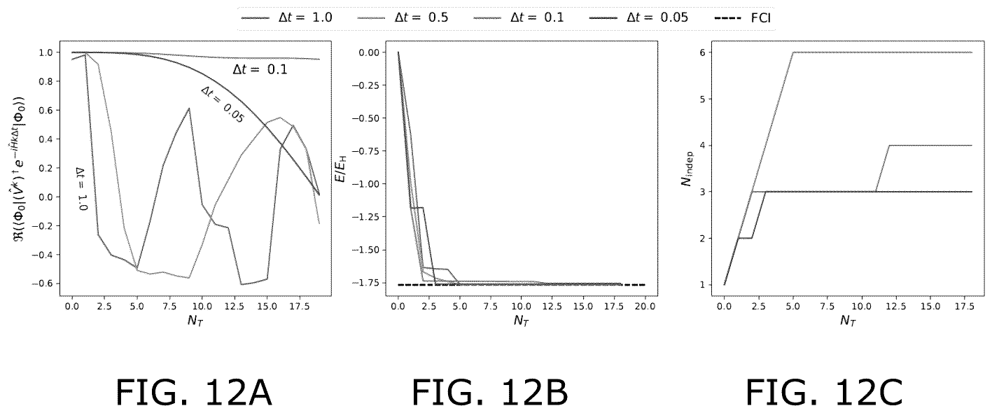

In FIGS. 11A-11C and 12A-12C, there are shown a series of state-vector VFF-based VQPE runs for a 2-site Hubbard model with U=0.5. FIGS. 11A-11C show computational results for VFF-based VQPE with U=0.5, fitted to a single time-step, for Δt ∈{0.05, 0.1, 0.5, 1.0}. The results include: calculated overlap between a k-th VFF state and a corresponding time-evolved state (A), the value of the VPQE energy (B) and the number of linearly independent states (C). The quality of the converged energy is directly linked to the number of independent states in the basis but shows no clear correlation to the overlap with the true time-evolved states.

FIGS. 12A-12C is an illustration of results for VFF-based VQPE with U=0.5, fitted to two time-steps for Δt ∈{0.05, 0.1, 0.5, 1.0}. The results include: overlap between the k-th VFF state and the corresponding time-evolved state, the of the VQPE energy (B), and the number of linearly independent states (C). It is found fast convergence even for calculations that do not span the full Hilbert space, suggesting using a second state in the fitting algorithms mitigates some of the triplet contamination.

In all cases, \hat{D} was truncated to m=1 and Ŵ was parameterised by a single-layer symmetry-preserving ansatz, leading to a circuit with a depth of 57 gates, of which 24 are CNOTs. This is a significant improvement from the original Trotterised time-evolution, particularly as the depth of this circuit remains constant for any number of steps. If more complex parameterisations are attempted, no significant change to the results are observed. For the n=1 case presented in FIG. 11, it is found that all methods that successfully generate 6 independent states converge to the true FCI energy, while those that do not fail to recover the true ground state. For n=2, all calculations converge to the ground state, even when spanning fewer independent states. Such a result suggests that fitting to more points decreases the contamination from mₛ=1 states. It is also noted that, as expected from the previous discussion of direct Hamiltonian diagonalization in the Krylov subspace, the quality of VFF agreement with the true time-evolved states has little correlation with the rate or quality of convergence, with the number of linearly independent states generated being the dominating factor by far.

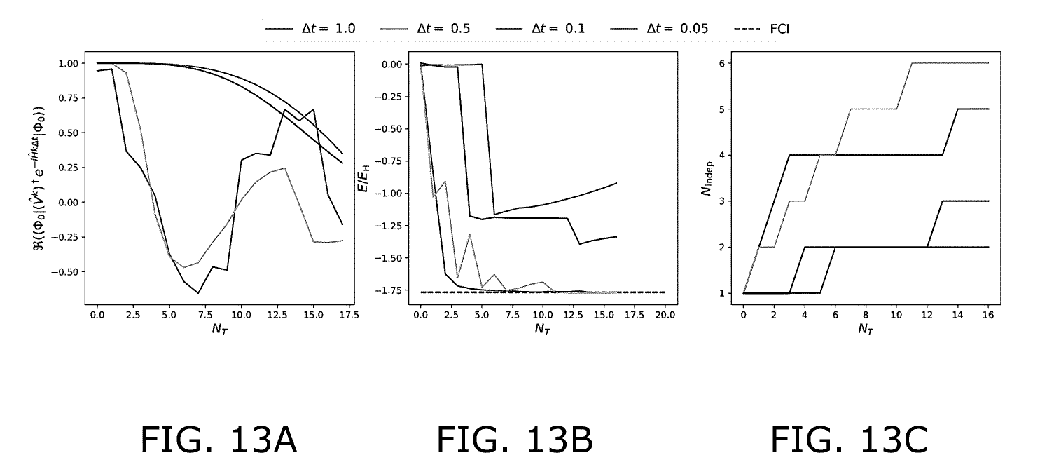

In FIGS. 13A-13C, there is shown an equivalent calculation to that in FIG. 12 performed using a shot-based circuit simulation. FIGS. 13A-13C is an illustration of results for VFF-based VQPE with U=0.5, fitted to two time-steps, for Δt∈(0.05, 0.1, 0.5, 10), using a shot-based quantum circuit simulator. The results include: the overlap between the k-th VFF state and the corresponding time-evolved state (A), the value of the VQPE energy (B), and the number of linearly independent states (C). Convergence is similar to state-vector simulations, but the presence of stochastic noise introduces noticeable kinks in the overlap and energy curves. The behaviour exhibited in qualitatively is similar to that of the state-vector simulations, although the effects of random noise are clearly visible in behaviour such as the unphysical upwards drift in the □t=0.05 energy. Nevertheless, larger time-steps lead to successful convergence to the ground state.

One of the significant advantages of VQPE is that, in the basis of time-evolved states, the overlap matrix S can be computed with linear cost due to Eq. (20). This computation remains rigorously the case for VFF approximate states, for which

$$\begin{matrix}{S}_{jk} = 〈 {Φ}_{0} \vert \hat{W} {\hat{D}}^{- j} {\hat{W}}^{†} \hat{W} {\hat{D}}^{k} {\hat{W}}^{†} \vert {Φ}_{0} 〉 \\ = 〈 {Φ}_{0} \vert \hat{W} {\hat{D}}^{- j} {\hat{D}}^{k} {\hat{W}}^{†} \vert {Φ}_{0} 〉 \\ = 〈 {Φ}_{0} \vert \hat{W} {\hat{D}}^{k - j} {\hat{W}}^{†} \vert {Φ}_{0} 〉 \\ = {S}_{j + n , k + n} \text{?} ∀ n ∈ ℤ .\end{matrix} \qquad ( 40 )$$

$$\text{?} \text{indicates text missing or illegible when filed}$$

Hamiltonian diagonalisation is resilient to a poor VFF approximation as its quality depends only on a basis set's ability to span the relevant support space. That is not the case for Eq. (16) with U defined as in Eq. (19). If the VFF states are poor approximations to the true time-evolved states,

$${U}_{jk} = Sj , k + 1 \neq 〈 {Φ}_{j} \vert {e}^{- i \hat{H} Δ T} \vert {Φ}_{k} 〉 , \qquad ( 41 )$$

the eigenvalues of U are no longer clearly related to the Hamiltonian eigenvalues. However, if the approximation if good enough, it is possible to employ this approach. When considering the □t=0.1 case for the Hubbard model in FIG. 12, it is feasible to attempt to construct the U matrix from the overlap. Table II gives the results of the diagonalization of a series of such matrices.

It is found that, on a large scale, the resulting energy converges with an improved overlap with the true energy; when close to perfect agreement, the resulting energy oscillates about the true FCI value. These results are promising and suggest that, given a reliably good Hamiltonian approximation, the VFF-based VQPE method can also be applied with only linear cost in the number of basis functions used.

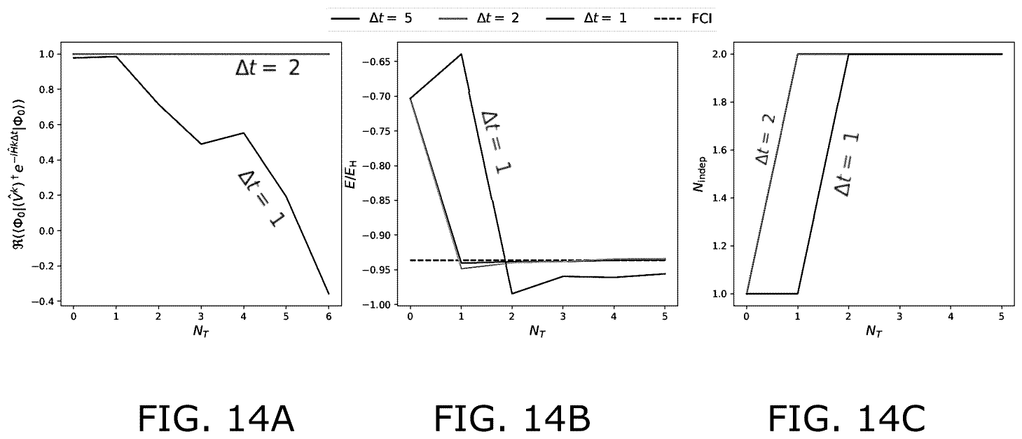

Finally, reference will be made back to H₂. While general physical Hamiltonians cannot necessarily be fast forwarded, it is found that in this case, it is possible to obtain a good VFF approximation to the time-evolution. Results obtained with VFF and VQPE for H₂ are given in FIGS. 14A-14C, fitted to two time-steps, for Δt∈{0.05, 0.1, 0.5, 1.0}, using a shot-based quantum circuit simulator. The results include: the overlap between the k-th VFF state and the corresponding time-evolved state (A), the value of the VQPE energy (B), and the number of linearly independent states (C).

In this case, there is observed a correlation between the quality of the overlap between the fast-forwarded state and the true time-evolved state, and the rate of convergence of VQPE.

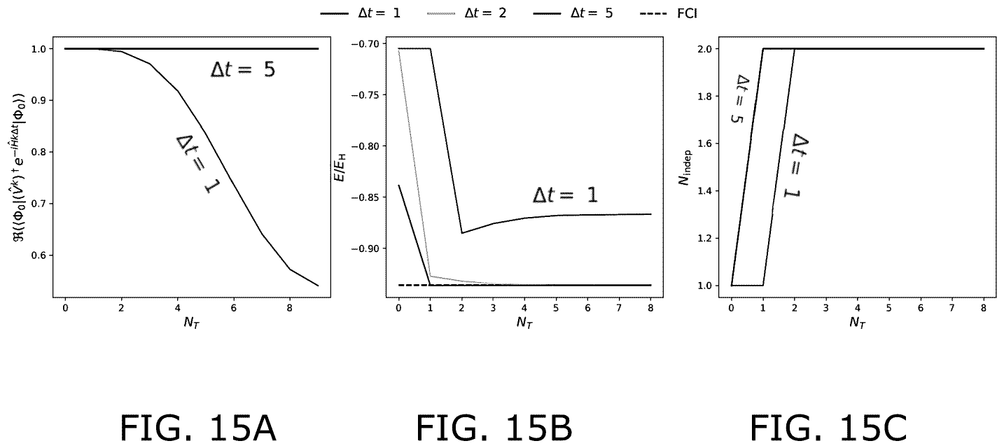

It is also found that, in most cases, the error in the overlap with the true Trotterized state is less than 10-6, so such a system can be well treated with the unitary approach, as can be seen in FIGS. 15A-15C is an illustration of results for VFF-based VQPE for H₂, fitted to two time-steps, for Δt ∈{0.05, 0.1, 0.5, 1.0}, using a shot-based quantum circuit simulator. The results include: the overlap between the k-th VFF state and a corresponding time-evolved state (A), the value of the VQPE energy (B), the number of linearly independent states (C). In this case, there is observed a correlation between the quality of the overlap between the fast-forwarded state and the true time-evolved state, and the rate of convergence of VQPE.

Table II shows error in the VQPE energy obtained by diagonalizing the U matrix as a function of minimum overlap between the VFF and time-evolved states. The error decreases as agreement between the two increases.

| min (Re{(ψ\|(V^{k}) [symbol] \|ψ)}) | E [symbol] − E [symbol] |
|---|---|
| 0.844 | 0.1639 |
| 0.852 | 0.1128 |
| 0.95570 | −0.0409 |
| 0.95744 | −0.0426 |
| 0.95748 | 0.0131 |

[symbol]

indicates data missing or illegible when filed

In conclusion, with reference to the foregoing, there is disclosed a circuit-based implementation for the VQPE algorithm based on Trotterized time propagation and the Hadamard test. Moreover, it is found that the method is successful in finding the ground state of the H₂ and H₃⁺ systems, but requires a prohibitively large number of one- and two-qubit gates to converge for H₆. This is an inevitable consequence of Trotterized time-evolution and would prevent this algorithm from finding significant use of NISQ devices.

In embodiments of the present disclosure, an approximation to the VQPE algorithm uses the VFF approach, which reduces the circuit depth of the time-evolution circuits to roughly that of a single Trotter step. The approximation provides a sensible Krylov subspace basis for Hamiltonian diagonalisation even when its fidelity to the true time-evolved basis is low. We find our particular choice of VFF decomposition natively preserves electron number but not mₛ values, unlike true time-evolution, so potentially requires more linearly independent states to reach the true ground state. This contamination can be reduced by using more time-evolved states in the cost function for VFF optimisation.

In general, VQPE based on VFF states requires construction of the Hamiltonian matrix, so a quadratic number of calls to the quantum processor. However, where [symbol] ψ|(V^{k})^{†}e^{-iHΔt}|Ψ [symbol] is close to unity across the entire range of VFF states considered, diagonalising the matrix U defined in Eq. (19) gives a good approximation to the true Hamiltonian eigenstates. In this case, VFF can be used to reduce required quantum circuit depth while maintaining the linear cost of matrix generation of exact VQPE.

In some implementation when VPQE in implemented using a Troterized time evolution operator, an ansatz may be needed. Advantageously, when the time evolution operator is approximated using VFF an ansatz may not be needed and the time evolution may start with the simplest possible initial state independent of the Hamiltonian.

In some cases, the VFF based implementation of the VQPE may provide some excited state of a quantum system in addition to its ground state (as opposed to classic VQPE and VQE that may only provide the ground state).

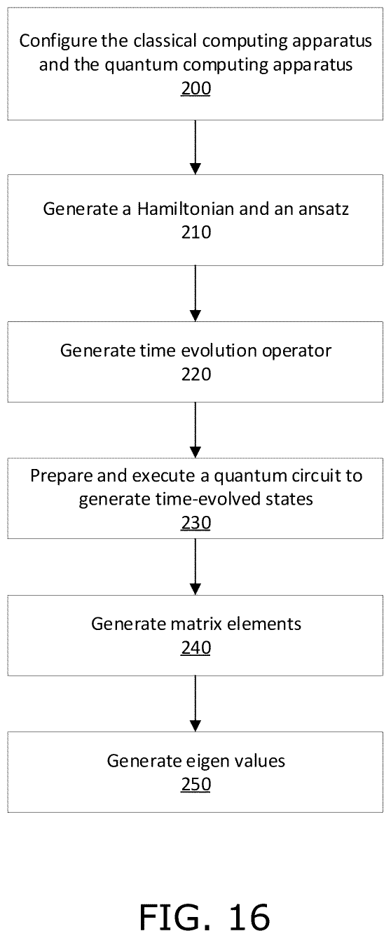

Referring next to FIG. 16, there are shown steps of a method of impelementing embodiments of the present disclosure on the quantum computing system 100 illustrated in FIG. 1. In FIG. 1, there is provided the quantum computing system 100, wherein the quantum computing system 100 includes a combination of the classical computing apparatus 110 coupled to the quantum computing apparatus 130. In the method:

Step 1 200 includes configuring the classical computing apparatus 110 and the quantum computing apparatus 130 to exchange data therebetween to execute a computing task for providing a simulation of a chemical system represented in input data provided in operation to the classical computing apparatus.

Step 2 210 includes configuring the quantum computing system 100 to generate a Hamiltonian, ansatz based on a fermionic representation of the chemical system derived from the input data.

Step 3 220 includes configuring the quantum computing system 100 to generate time evolution operator based on variational fast forward (VFF) algorithm.

Step 4 230 includes configuring the quantum computing system to prepare a quantum circuit using at least the time evolution operator and execute the quantum circuit to generate time-evolved states.

Step 5 240 includes configuring the quantum computing system 100 to use the time-evolved states to generated and measure the matrix elements of an overlap operator, a unitary time evolution operator, and/or the Hamiltonian operator.

Step 6 250 includes configuring the quantum computing system 100 to generate the eigenstates and values using the matrix elements.

Optionally, the method includes configuring the quantum computing system 100 to compute the variational phase estimation based on states generated by the variational fast forward computation. More optionally, the method includes configuring the quantum computing system 100 to generate one or more initial time-evolved states for use in the variational phase estimation by using a state-vector simulation of the Hamiltonian. More optionally, the method includes configuring the quantum computing system 100 to use a symmetry-preserving ansatz for the ansatz used to generate the quantum circuit to be executed by the quantum computing apparatus.

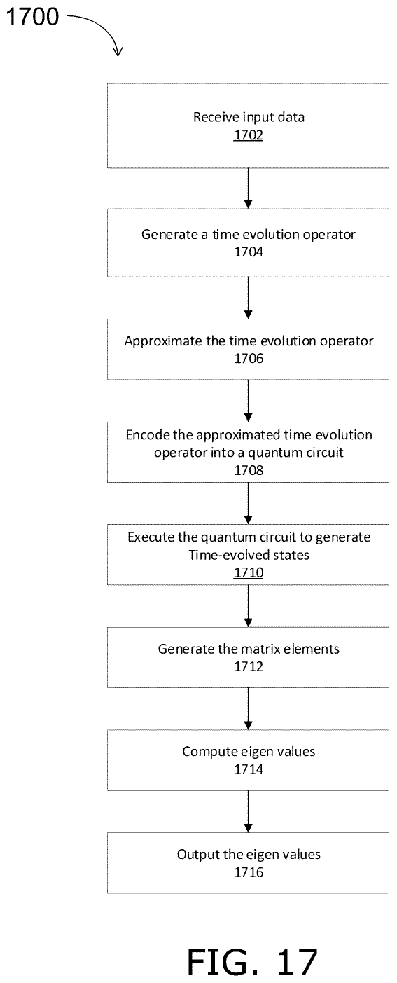

FIG. 17 is a flow diagram illustrating an example processes 1700 and 1800 that may be used by a quantum computing system (e.g., quantum computing system 100) to determine an energy of an eigenstate (e.g., the ground state) of quantum system (e.g., a molecule). In some cases, the process 1700 may be performed by a hardware processor of the quantum computing system (e.g., the hardware processor of the classical computing system 110) using the quantum computer 130. In some cases, a first portion of computational steps may be performed using the classical computing system 110 and a second portion of the computational steps may be performed using the quantum computer 130. The quantum computer 130 may be configured based on the result of the first computational steps, and the results (e.g., measurement results) generated by the quantum computer 130 may be used by the classical computing system 110 to calculate the energy of the eigenstates of the quantum system (e.g., the molecule).

The process 1700 begins at block 1702 where the quantum computing system receives input data from a data source. In some cases, the data source can be a user interface of the quantum computing system (e.g., a user interface of the classical computer). In some cases, the data source may include a memory (e.g., a non-transitory memory of a computing system separate from the quantum computing system). In some examples, the data source can be a user providing input data via user interface of the quantum computing system 100 or a user interface in communication (e.g., via wired or wireless data link) with the quantum computing system. In some examples, the input data may be stored in a memory of the quantum computing system 100.

In some cases, input data may include: a Hamiltonian (e.g., a chemical Hamiltonian), data usable for generating the Hamiltonian, an ansatz, a reference function, a time step size, an arithmetic function, and the like.

At block 1704, the quantum computing system 100 may use the input data to generate a time evolution operator for generating a Krylov subspace in a Hilbert space. In some cases, the classical computing system 110 may generate the time evolution operator based at least in part on the Hamiltonian received or calculated at block 1702. In some embodiments, the classical computing system 110 may expand the Hamiltonian to generate an equivalent Hamiltonian comprising a series of Pauli strings and used the equivalent Hamiltonian to generate the time evolution operator.

At block 1706, the classical computing system 110 may use approximate the time evolution operator.

In some implementations, the classical computing system 110 may approximate the time evolution operator using first order Trotter-Suzuki approximation for a finite time step of the whole evolution. In these implementations, the approximated time evolution operator may comprise a series of operators each comprising a Pauli string.

In some other implementations, the classical computing system 110 may approximate the time evolution operator using Variational Fast Forwarding (VFF). For example, the classical computing system 110 may generate an approximate time evolution operator of the form WDW^{†} where W is a unitary operator for time evolution and D is a diagonal operator defining a duration of the time evolution. The classical computing system 110 may parametrize W using a symmetry preserving ansatz.

At block 1708, the classical computing system 110 may use encode the approximated time evolution operator into a quantum circuit in the quantum computer 130. For example, classical computing system 110 may execute a configuration and control algorithm to generate and configure the quantum circuit using quantum gates such as Hadamard, Pauli gates, and other types of quantum gates.

In some examples, the quantum circuit may comprise a control Pauli gadget shown in FIG. 3. In some cases, the encoded quantum circuit may be controlled onto an ancilla.

In some implementations, the approximate time evolution operator WDW^{†} may be encoded in a quantum circuit of the quantum computer 130 that performs the time steps and generates the time-evolved states. In these implementations, the corresponding quantum circuit may comprise number preserving quantum gates.

At block 1710, the quantum computing system 100 may execute the quantum circuit configured at block 1708 to generate time-evolved states. In some implementations, the time steps may be equally spaced and form a uniform time grid.

In some cases, the quantum computing system 100 may generate the time-evolved states based at least in part a reference state. The reference state may be included in or extracted from the input data. In some cases, the quantum computing system 100 may determine the reference state based on the Hamiltonian. In some cases, the reference state can be a Hartree-Fock state.

Advantageously, when the approximate time evolution operator comprises WDW^{†}, the depth of the quantum circuit used to generate the time-evolved states may be independent of the number of time steps performed and therefore the depth of quantum circuit remains constant even for more complex quantum systems (e.g., molecules having many atoms) where more time steps are required.

At block 1712, the quantum computing system 100 may use a measurement circuit of the quantum computer 130 to generate the matrix elements of an overlap matrix associated with the time evolution operator. In some cases, when time steps are equally spaces (e.g., time steps of a uniform time grid), the quantum computing system 100 may construct the full overlap matrix by computing one row of the matrix elements. Advantageously, in these cases, the number of measurements required for generating the full overlap matrix can be reduced and the full overlap matrix can be generated faster and using less quantum resources or quantum circuits with smaller depth. Alternatively or in addition the quantum computing system 100 may measure and compute a matrix element of the Hamiltonian matrix.

At block 1714, the classical computing system 110 may use matrix elements of the overlap matrix and/or those of the Hamiltonian matrix to estimate at least on energy of an eigenstate of the Hamiltonian. The at least one eigenstate may comprise an eigenvalue or an energy of a ground state or excited state of the quantum system of interest. In some cases, the classical computing system 110 may estimate both the ground and excited states of the quantum system (e.g., a molecule).

At block 1716, the classical computing system 110 may output the computed eigen values and/or the eigen states by transmitting them to a data communication interface, a user interface, a display system, or another computing system.

### Additional Example Quantum Computing Systems

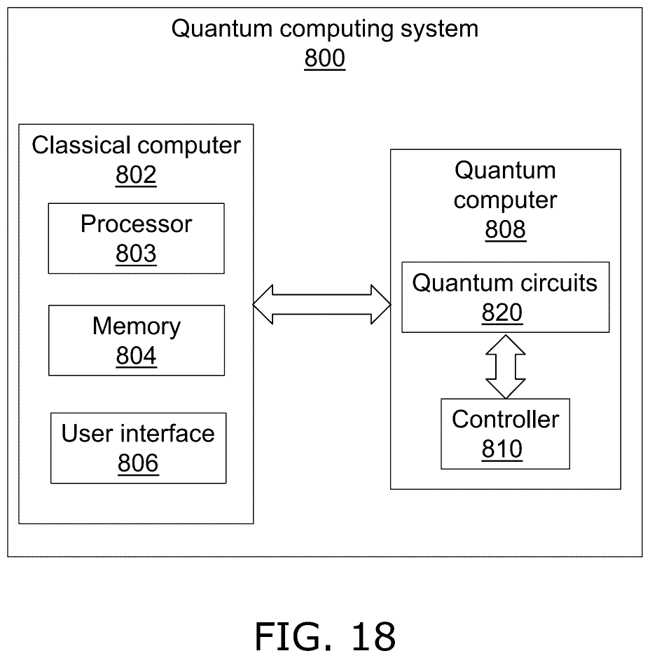

FIG. 18. is block diagram that provides an illustration of an example quantum computing system 800 that includes a classical computer 802 combined with a quantum computer 808. In some cases, the classical computer 802 and the quantum computer 808, may be included or integrated in the same housing. The classical computer 802 may include a user interface 806, first hardware processor 803 and a first non-transitory memory 804. The quantum computer 808 may have a controller 810 that includes a second hardware processor and a second non-transitory memory (not shown). In some cases, the classical computer 802 may execute computer-executable instructions stored in the first non-transitory memory 804 to: control the operation of the classical computer 802, the flow of data between the classical computer 802 and the quantum computer 808, and control, at least in part, the operation of the classical computer 802. In some cases, the classical computer may send data and commands to the controller 810 and the controller 810 may configure one or more quantum circuits 812 according to the data and commands received from the classical computer 802.

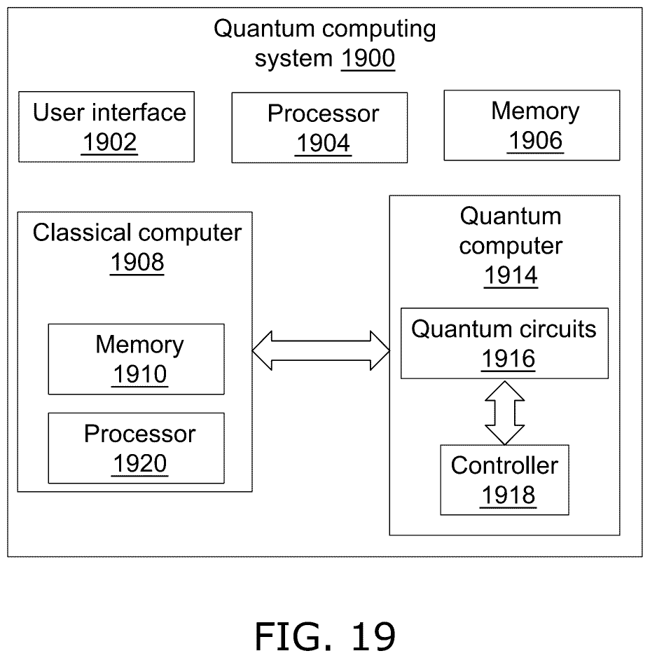

FIG. 19 is a block diagram that provides an illustration of an example quantum computing system 1900 that includes a user interface 1902, a first hardware processor 1904, and a first non-transitory memory 1906, a classical computer 1908, and a quantum computer 1914. The classical computer 1908 may include a second hardware processor 1920 and a second non-transitory memory 1910. The quantum computer 1914 may have a controller 1918 that includes a third hardware processor and a third non-transitory memory (not shown). In some cases, the quantum computing system 1900 may execute computer-executable instructions stored in the first non-transitory memory 1906 to: control the operation of the classical computer 1908 and the quantum computer 1914, control a flow of data between the classical computer 1908 and the quantum computer 1914, control a flow of data between the user interface 1902 and the memory 1906, control a flow of data between the classical computer 1908, and the quantum computer 1914. In some implementations, the classical computer 1908 may execute computer-executable instructions stored in the second non-transitory memory 1910 to: receive input data from the user interface 1902 and generate configuration data usable for configuring the quantum computer 1914. In some such implementations, the controller 1918 may execute computer-executable instructions stored in the third non-transitory memory to: receive configuration data from the classical computer 1908, configure the quantum circuits 1916 according to configuration data, and execute a quantum algorithm using the configured quantum circuits 1916. In various implementations, the controller 1918 may receive the quantum algorithm and/or commands associated with the quantum algorithm from the user interface 1902, the memory 1906, the memory 1910, the processor 1920, or the processor 1904.

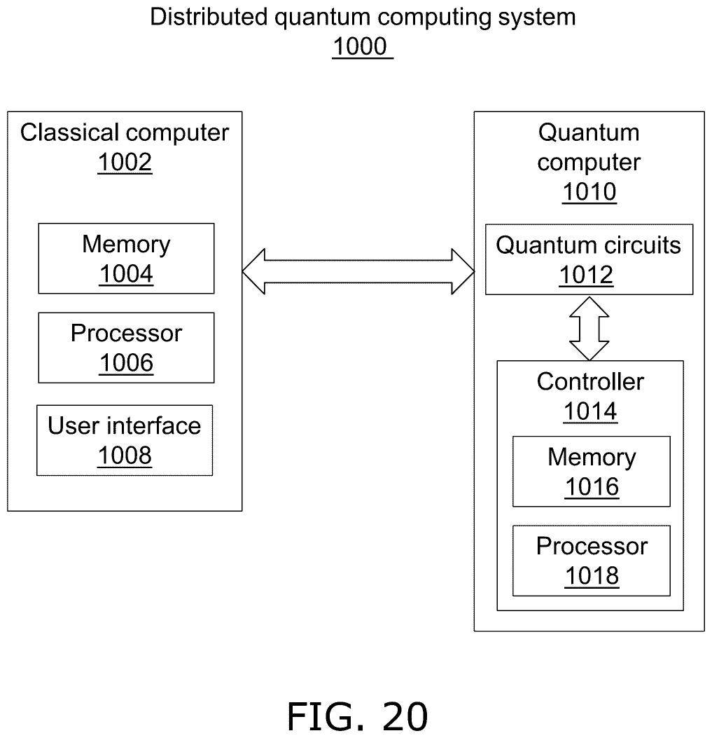

FIG. 20 is a block diagram that provides an illustration of an example distributed quantum computing system 1000 that includes a classical computer 1002 and a quantum computer 1010 where the classical computer 1002 and the quantum computer 1010 are separate systems. In some cases, the classical computer 1002 and the quantum computer 1010 can be in communication via a data link. The data link can be a wired or wireless data link. The wireless data link may comprise a local area network (LAN), a Wi-Fi connection, or a wide area network (WLAN).

The classical computer may include a first hardware processor 1006, a first non-transitory memory 1004, and a user interface 1008. The quantum computer 1010 may include a controller 1014 that includes a second hardware processor 1018 and a second non-transitory memory 1016. The Controller 1014 can be configured to construct and/or configure quantum circuits 1012 based at least in part on data (e.g., configuration data) received from the classical computer 1002 via the communication link. In some implementations, the classical computer 1002 may execute computer-executable instructions stored in the first non-transitory memory 1004 to: receive input data from the user interface 1008 and generate configuration data usable for configuring the quantum computer 1010 (e.g., by the controller 1014 of the quantum computer 1010). In some such implementations, the controller 1014 may execute computer-executable instructions stored in the second non-transitory memory 1016 to: receive configuration data from the classical computer 1002, configure the quantum circuits 1012 according to configuration data, and execute a quantum algorithm using the configured quantum circuits 1012. In various implementations, the controller 1014 may receive the quantum algorithm and/or commands associated with the quantum algorithm from the classical computer 1002. In some examples, at least a portion of the quantum algorithms may be stored in the memory 1016.

In some cases, the quantum computer can be a quantum computer based on any quantum computing technology (e.g., trapped ions, photons, superconducting circuits, and the like).

In some cases, a quantum computer (e.g., the quantum computer 808, 1914, or 1010) may comprise a plurality of quantum computers interconnected, for example, using quantum communication channels and/or shared entanglement.

In various implementations, any of the computational methods described above (e.g., VQPE using Trotterization or VFF), may be implemented using the quantum computing systems 800, 1900, or 1000. For example, any of the quantum computing systems 800, 1900, or 1000 may perform the computational processes described with respect to FIG. 16 or 17.

### Example Embodiments

Some additional nonlimiting examples of embodiments discussed above are provided below. These should not be read as limiting the breadth of the disclosure in any way.

### Group 1

Example 1. A quantum computing system including a combination of a classical computing apparatus coupled to a quantum computing apparatus, wherein the classical computing apparatus and the quantum computing apparatus are configured to exchange data therebetween to execute a computing task for providing a simulation of a chemical system represented in input data provided in operation to the classical computing apparatus, wherein the simulation is provided from the classical computing device using computed output results generated by the quantum computing apparatus in response to computational tasks being provided to the quantum computing apparatus from the classical computing apparatus based upon the input data, wherein the quantum computing system is configured to generate a Hamiltonian and an ansatz based on a fermionic representation of the chemical system derived from the input data, and wherein the quantum computing apparatus is configured to execute a quantum circuit derived from the ansatz and the Hamiltonian to compute one or more eigenvalues for use in generating the output results, wherein the quantum computing apparatus is configured to evaluate the quantum circuit to compute the one or more eigenvalues representative of the chemical system by using a combination of variational quantum phase estimation (VQPE) and variational fast forward (VFF) computations.

Example 2. The quantum computing system of Example 1 of this Group 1, wherein the quantum computing system is configured to compute the variational phase estimation based on states generated by the variational fast forward computation.

Example 3. The quantum computing system of Example 2 of Group 1, wherein the quantum computing system is configured to generate one or more initial time-evolved states for use in the variational phase estimation by using a state-vector simulation of the Hamiltonian.

Example 4. The quantum computing system of any one of Examples 1 to 3 of Group 1, wherein the quantum computing system is configured to use a symmetry-preserving ansatz for the ansatz used to generate the quantum circuit to be executed by the quantum computing apparatus.

Example 5. A method for using a quantum computing system, wherein the quantum computing system includes a combination of a classical computing apparatus coupled to a quantum computing apparatus, wherein the method includes:
a. configuring the classical computing apparatus and the quantum computing apparatus to exchange data therebetween to execute a computing task for providing a simulation of a chemical system represented in input data provided in operation to the classical computing apparatus;
b. configuring the quantum computing system to generate a Hamiltonian and an ansatz based on a fermionic representation of the chemical system derived from the input data;
c. configuring the quantum computing apparatus to execute a quantum circuit derived from the ansatz and the Hamiltonian to generate the output results; and
d. configuring the quantum computing system to provide the simulation from the classical computing device using computed output results including one or more eigenvalues generated by the quantum computing apparatus in response to computational tasks being provided to the quantum computing apparatus from the classical computing apparatus based upon the input data; and
e. configuring the quantum computing apparatus to evaluate the quantum circuit to compute the one or more eigenvalues representative of the chemical system by using a combination of variational quantum phase estimation (VQPE) and variational fast forward (VFF) computations.

Example 6. The method of Example 5 of Group 1, wherein the method includes configuring the quantum computing system (100) to compute the variational phase estimation based on states generated by the variational fast forward computation.

Example 7. The method of Example 6 of Group 1, wherein the method includes configuring the quantum computing system (100) to generate one or more initial time-evolved states for use in the variational phase estimation by using a state-vector simulation of the Hamiltonian.

Example 8. The method of any one of Examples 5 to 7 of Group 1, wherein the method includes configuring the quantum computing system (100) to use a symmetry-preserving ansatz for the ansatz used to generate the quantum circuit to be executed by the quantum computing apparatus.

Example 9. A transitory computer-readable storage medium comprising specific computer-readable instructions executable on data processing hardware, wherein the specific computer-readable instructions, when executed the data processing hardware, implement the method of any one of Examples 5 to 8 of Group 1.

Example 10. A quantum circuit that is representative of a chemical system as generated using the method of any one of Examples 5 to 8 of Group 1, wherein the quantum circuit is arranged to compute the one or more eigenvalues representative of the chemical system by using a combination of variational quantum phase estimation (VQPE) and variational fast forward (VFF) computations.

### Group 2

Example 1. A quantum computing system configured to determine the energy of an eigenstate of a quantum system, the quantum computing system comprising:
a quantum computer comprising:
   quantum gates configured to act on qubits to generate processed qubits, wherein the quantum gates are usable for building quantum circuits; and
   at least one measuring device configured to determine states of the processed qubits to generate measurement data; and
   a classical computing system in communication with the quantum computer, the classical computing system comprising a non-transitory memory configured to store specific computer-executable instructions and a hardware processor in communication with the non-transitory memory, wherein the hardware processor is configured to execute the specific computer-executable instructions to at least:
      receive input data,
      configure a first quantum circuit, based at least in part on the input data, to generate time evolved quantum states;
      configure a second quantum circuit, based at least in part on the first quantum circuit, to determine a matrix element of at least a Hamiltonian representing the quantum system, using the time evolved quantum states; and
      generate the eigenstate using the matrix element.

Example 2. The quantum computing system of Example 1 of Group 2, wherein the quantum system comprises a molecular system and the Hamiltonian is a molecular Hamiltonian.

Example 3. The quantum computing system of Example 2 of Group 2, wherein the Hamiltonian comprises fermionic creation and annihilation operators.

Example 4. The quantum computing system of any one of Examples 1 to 3 of Group 2, wherein the quantum gates comprise one or both Hadamard gate and Pauli gate.

Example 5. The quantum computing system of any one of Examples 1 to 4 of Group 2, wherein the first quantum circuit generates the time evolved quantum states using multiple time-steps.

Example 6. The quantum computing system of Example 5 of Group 2, wherein the multiple time-steps form a uniform time grid.

Example 7. The quantum computing system of any one of Examples 1 to 6 of Group 2, wherein the a first quantum circuit comprises a Trotter-Suzuki approximation of a time evolution operator associated with the Hamiltonian, and wherein the hardware processor is configured to process input data to generate the Trotter-Suzuki approximation of the time evolution operator.

Example 8. The quantum computing system of any one of Examples 1 to 7 of Group 2, wherein the hardware processor configures the first quantum circuit by compiling an approximated time evolution operator based on Variational Fast Forwarding (VFF) and using the input data.

Example 9. The quantum computing system of Example 8 of Group 2, wherein the first quantum circuit operator comprises number preserving quantum gates.

Example 10. The quantum computing system of Example 8 of Group 2, wherein the approximated time evolution operator comprises WDⁿ W^{†} wherein W is a unitary operator, D is a diagonal operator, and n is a number of evolution time steps.

Example 11. The quantum computing system of Example 10 of Group 2, wherein W is parameterized using a symmetry preserving ansatz.

Example 12. The quantum computing system of Example 8 of Group 2, wherein a quantum depth of at least the first quantum circuit is independent of a number of time-steps used to generate the time evolved quantum states.

Example 13. The quantum computing system of any one of Examples 1 to 12 of Group 2, wherein the input data comprises the Hamiltonian.

Example 14. The quantum computing system of any one of Examples 1 to 13 of Group 2, wherein the second quantum circuit comprises a Hadamard test.

Example 15. The quantum computing system of any one of Examples 1 to 14 of Group 2, wherein the second quantum circuit is configured to determine the matrix element of the Hamiltonian based at least in part on a reference quantum state.

Example 16. The quantum computing system of Example 15 of Group 2, wherein the reference state is included in the input data.

Example 17. The quantum computing system of Example 15 of Group 2, wherein the reference state is the Hartree-Fock state.

Example 18. The quantum computing system of Example 15 of Group 2, wherein the time evolved quantum states form a Krylov subspace in a Hilbert space.

Example 19. The quantum computing system of any one of Examples 1 to 18 of Group 2, wherein the hardware processor generates the eigenstate by solving a generalized eigen value equation.

Example 20. The quantum computing system of Example 7 of Group 2, wherein the first quantum circuit comprises a succession of controlled Pauli gadgets. Thus, the Trotter-Suzuki expansion, which is in a fermionic form, is transformed to a quantum circuit representation as a series of Pauli gadgets.

Example 21. The quantum computing system of any one of Examples 1 to 20 of Group 2, wherein the measurement device is configured to measure a quantum state generated by the second quantum circuit to generate the matrix element.

Example 22. The quantum computing system of any one of Examples 1 to 21 of Group 2, wherein the measurement device comprises the second quantum circuit.

Example 23. The quantum computing system of any of Examples 7 or 8 of Group 2, wherein the time evolution operator comprises Pauli strings. This is a transformation of the fermionic representation to a quantum gate representation.

Example 24. A method of operating a quantum computing system for determining an energy of an eigenstate of a quantum system, wherein the quantum computing system comprises a quantum computer in communication with a classical computing system and the classical computing system comprises a hardware processor in communication with the non-transitory memory storing computer executable instructions, the method comprising, by the hardware processor:
receiving input data,
configuring a first quantum circuit, based at least in part on the input data,
generating time evolved quantum states using the first quantum circuit;
configuring a second quantum circuit, based at least in part on the first quantum circuit,
determining a matrix element of at least a Hamiltonian representing the quantum system, using the second quantum circuit and the time evolved quantum states;
generating the eigenstate using the matrix element.

Example 25. The method of Example 24 of Group 2, wherein the quantum system comprises a molecular system and the Hamiltonian is a molecular Hamiltonian.

Example 26. The method of Example 25 of Group 2, wherein the Hamiltonian comprises fermionic creation and annihilation operators.

Example 27. The method of any one of Examples 24 to 26 of Group 2, wherein generating time evolved quantum states comprises generating the time evolved quantum states using multiple time-steps.

Example 28. The method of Example 27 of Group 2, wherein the multiple time-steps form a uniform time grid.

Example 29. The method of any one of Examples 24 to 28 of Group 2, further comprising processing the input data to generate a Trotter-Suzuki approximation of a time evolution operator associated with the Hamiltonian, wherein configuring the first quantum circuit comprises configuring the first quantum circuit using the Trotter-Suzuki approximation of the time evolution operator.

Example 30. The method of any one of Examples 24 to 29 of Group 2, wherein configuring the first quantum circuit comprises compiling an approximated time evolution operator based on Variational Fast Forwarding (VFF).

Example 31. The method of Example 30 of Group 2, wherein the first quantum circuit operator comprises number preserving quantum gates.

Example 32. The method of Example 30 of Group 2, wherein the approximated time evolution operator comprises evolution operator WDⁿ W^{†} wherein W is a unitary operator, D is a diagonal operator, and n is a number of evolution time steps.

Example 33. The method of Example 32 of Group 2, wherein W is parametrized using a symmetry preserving ansatz.

Example 34. The method of Example 30 of Group 2, wherein a quantum depth of at least the first quantum circuit is independent of a number of time-steps used to generate the time evolved quantum states.

Example 35. The method of any one of Examples 24 to 34 of Group 2, wherein the second quantum circuit comprises a Hadamard test.

Example 36. The method of any one of Examples 24 to 35, wherein the second quantum circuit is configured to determine the matrix element of the Hamiltonian based at least in part on a reference quantum state.

Example 37. The method of Example 36 of Group 2, wherein the reference quantum state is included in the input data.

Example 38. The method of Example 37 of Group 2, wherein the reference quantum state is a Hartree-Fock state.

Example 39. The method of any one of Examples 24 to 38 of Group 2, wherein the time evolved quantum states form a Krylov subspace in a Hilbert space.

Example 40. The method of any one of Examples 24 to 39 of Group 2, wherein generating the eigenstate comprises solving a generalized eigen value equation.

Example 41. The method of Example 29 of group 2, wherein the first quantum circuit comprises a succession of controlled Pauli gadgets.

Example 42. The method of any one of Examples 24 to 41 of Group 2, wherein generating the matrix element comprises measuring a quantum state generated by the second quantum circuit.

Example 43. The method of any one of Examples 29 or 30 of Group 2, wherein the time evolution operator comprises Pauli strings.

Example 44. A non-transitory computer-readable storage medium comprising specific computer-readable instructions executable on data processing hardware, wherein the specific computer-readable instructions, when executed by the data processing hardware, implement the method of any one of Examples 24 to 43 of Group 2.

### Group 3

Example 1. A quantum computing system configured to determine an energy of an eigenstate of a quantum system, the quantum computing system comprising:
a quantum computer comprising:
quantum gates configured to act on qubits to generate processed qubits, wherein the quantum gates are usable for building quantum circuits; and
at least one measuring device configured to determine states of the processed qubits to generate measurement data; and
a classical computing system in communication with the quantum computer, the classical computing system comprising a non-transitory memory configured to store specific computer-executable instructions and a hardware processor in communication with the non-transitory memory, wherein the hardware processor is configured to execute the specific computer-executable instructions to at least:
   receive input data,
   configure a quantum circuit comprising a time evolution operator approximated using Variational Fast Forwarding (VFF) to generate time evolved quantum states, wherein the time evolution operator is associated with a Hamiltonian of the quantum system;
   configure the measuring device to measure a quantum state comprising the time evolved quantum states to determine at least one matrix element of an overlap matrix; and
   determine the energy of an eigenstate using the at least one matrix element.

Example 2. The quantum computing system of Example 1 of Group 3, wherein the quantum system comprises a molecular system and the Hamiltonian is a molecular Hamiltonian.

Example 3. The quantum computing system of Example 2 of group 3, wherein the Hamiltonian comprises fermionic creation and annihilation operators.

Example 4. The quantum computing system of any one of Examples 1 to 3 of Group 3, wherein the hardware processor determines the matrix element of the overlap matrix using a reference state.

Example 5. The quantum computing system of Example 4 of Group 3, wherein the input data comprises the reference state.

Example 6. The quantum computing system of any one of Examples 1 to 5 of Group 3, wherein the quantum circuit generates the time evolved quantum states using multiple evolution time-steps.

Example 7. The quantum computing system of Example 6 of Group 3, wherein the multiple evolution time-steps form a uniform time grid.

Example 8. The quantum computing system of any one of Examples 1 to 7 of Group 3, wherein the quantum circuit operator comprises number preserving quantum gates.

Example 9. The quantum computing system of Example 6 of Group 3, wherein the time evolution operator comprises WDⁿ W^{†} wherein W is a unitary operator, D is a diagonal operator, and n is a number of evolution time steps.

Example 10. The quantum computing system of Example 9 of Group 3, wherein W is parametrized using a symmetry preserving ansatz.

Example 11. The quantum computing system of Example 6 of Group 3, wherein a quantum depth of the quantum circuit is independent of a number of evolution time-steps used to generate the time evolved quantum states.

Example 12. The quantum computing system of any one of Examples 1 to 11 of Group 3, wherein the input data comprises the Hamiltonian.

Example 13. The quantum computing system of any one of Examples 1 to 12 of Group 3, wherein the hardware processor determines the at least one matrix element of the overlap matrix using a Hadamard test protocol.

Example 14. The quantum computing system of any one of Examples 1 to 13 of Group 3, wherein the time evolved quantum states form a Krylov subspace in a Hilbert space.

Example 15. The quantum computing system of any one of Examples 1 to 14 of Group 3, wherein the hardware processor determines the energy of an eigenstate by solving a generalized eigen value equation.

Example 16. The quantum computing system of Example 15 of Group 3, wherein solving the generalized eigen value equation comprises diagonalizing the overlap matrix.

Example 17. The quantum computing system of any one of Examples 1 to 16 of Group 3, wherein the hardware processor determines the energy of an eigenstate using a variational quantum phase estimation (VQPE) algorithm.

Example 18. The quantum computing system of any one of Examples 1 to 17 of Group 3, wherein the time evolved quantum states comprise approximate time evolved quantum states different from exact time evolved states.

Example 19. The quantum computing system of Example 18 of Group 3, wherein the exact time evolved states are generated using a time evolution operator expressed as exp(-iH□t), where in H is the Hamiltonian of the quantum system.

Example 20. The quantum computing system of any one of Examples 1 to 19 of Group 3, wherein time evolved quantum states are non-orthogonal.

Example 21. A method of operating a quantum computing system for determining an energy of an eigenstate of a quantum system, wherein the quantum computing system comprises a quantum computer in communication with a classical computing system and the classical computing system comprises a hardware processor, the method comprising, by the hardware processor:
receiving input data,
configuring a quantum circuit comprising a time evolution operator approximated using Variational Fast Forwarding (VFF) to generate time evolved quantum states, wherein the time evolution operator is associated with a Hamiltonian of the quantum system;
measuring a quantum state comprising the time evolved quantum states;
determining at least one matrix element of an overlap using the measured quantum state; and
determining the energy of an eigenstate using the matrix element.

Example 22. The method of Example 21 of Group 3, wherein the quantum system comprises a molecular system and the Hamiltonian is a molecular Hamiltonian.

Example 23. The method of Example 22 of Group 3, wherein the Hamiltonian comprises fermionic creation and annihilation operators.

Example 24. The method of any one of Examples 21 to 23 of Group 3, wherein determining the matrix element of the overlap matrix comprises determining the matrix element using a reference state. using a reference state.

Example 25. The method of Example 24 of Group 3, wherein the input data comprises the reference state.

Example 26. The method of any one of Examples 21 to 25 of Group 3, wherein generating time evolved quantum states comprises generating the time evolved quantum states using multiple time-steps.

Example 27. The method of Example 26 of Group 3, wherein the multiple evolution time-steps form a uniform time grid.

Example 28. The method of any one of Examples 21 to 27 of Group 3, wherein the quantum circuit comprises number preserving quantum gates.

Example 29. The method of Example 26 of Group 3, wherein the time evolution operator comprises WDⁿW^{†} wherein W is a unitary operator, D is a diagonal operator, and n is a number of evolution time steps.

Example 30. The method of Example 29 of Group 3, wherein W is parametrized using a symmetry preserving ansatz.

Example 31. The method of Example 26 of Group 3, wherein a quantum depth of the quantum circuit is independent of a number of evolution time-steps used to generate the time evolved quantum states.

Example 32. The method of any one of Examples 21 to 31 of Group 3, wherein the input data comprises the Hamiltonian.

Example 33. The method of any one of Examples 21 to 32 of Group 3, wherein determining the at least one matrix element of the overlap matrix comprises determining the at least one matrix element using a Hadamard test protocol.

Example 34. The method of any one of Examples 21 to 33 of Group 3, wherein the time evolved quantum states form a Krylov subspace in a Hilbert space.

Example 35. The method of any one of Examples 21 to 34 of Group 3, wherein determining the energy of an eigenstate comprises solving a generalized eigen value equation.

Example 36. The method of Example 35, wherein solving the generalized eigen value equation comprises diagonalizing the overlap matrix.

Example 37. The method of any one of Examples 21 to 36 of Group 3, wherein determining the energy of eigenstates comprises determining the energy of eigenstates using a variational quantum phase estimation (VQPE) algorithm.

Example 38. The method of any one of Examples 21 to 37 of Group 3, wherein the time evolved quantum states comprise approximate time evolved quantum states different from exact time evolved states.

Example 39. The method of Example 38 of Group 3, wherein the exact time evolved states are generated using a time evolution operator expressed as exp(-iH□t), where in H is the Hamiltonian of the quantum system.

Example 40. The method of any one of Examples 21 to 39 of Group 3, wherein time evolved quantum states are non-orthogonal.

Example 41. A non-transitory computer-readable storage medium comprising specific computer-readable instructions executable on data processing hardware, wherein the specific computer-readable instructions, when executed by the data processing hardware, implement the method of any one of Examples 21 to 40 of Group 3.

### Terminology

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural; as an example, “at least one of” indicates “one of” in an example, and “a plurality of” in another example; moreover, “two of”, and similarly “one or more” are to be construed in a likewise manner. Numerals included within parentheses in the accompanying claims are intended to assist understanding of the claims and should not be construed in any way to limit subject matter claimed by these claims.

The phrases “in an embodiment”, “according to an embodiment” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

The term “computer” or “computing-based device” is used herein to refer to any device with processing capability such that it executes instructions. Those skilled in the art will realize that such processing capabilities are incorporated into many different devices and therefore the terms “computer” and “computing-based device” each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible, non-transitory storage medium, e.g., in the form of a computer program comprising computer program code adapted to perform the operations of one or more of the methods described herein when the program is run on a computer and where the computer program may be embodied on a non-transitory computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed or execute some software instructions at the local terminal and some at the remote computer (or computer network). Those skilled in the art will also realize that by utilizing techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. No single feature or group of features is necessary or indispensable to every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, blocks, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of: A, B, or C” is intended to cover: A; B; C; A and B; A and C; B and C; and A, B, and C. Conjunctive language such as the phrase “at least one of X, Y, and Z,” unless specifically stated otherwise, is otherwise understood with the context as used in general to convey that an item, term, etc. may be at least one of X, Y, or Z. Thus, such conjunctive language is not generally intended to imply that certain embodiments require at least one of X, at least one of Y, and at least one of Z to each be present.

The operations of the methods described herein may be carried out in any suitable order, or simultaneously where appropriate. Additionally, individual blocks may be deleted from, combined with other blocks, or rearranged in any of the methods without departing from the scope of the subject matter described herein. Aspects of any of the examples described above may be combined with aspects of any of the other examples described to form further examples without losing the effect sought.

It will be understood that the above description is given by way of example only and that various modifications may be made by those skilled in the art. The above specification, examples, and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A quantum computing system configured to determine an energy of an eigenstate of a quantum system, the quantum computing system comprising:
a quantum computer comprising:
quantum gates configured to act on qubits to generate processed qubits, wherein the quantum gates are usable for building quantum circuits; and
at least one measuring device configured to determine states of the processed qubits to generate measurement data; and
a classical computing system in communication with the quantum computer, the classical computing system comprising a non-transitory memory configured to store specific computer-executable instructions and a hardware processor in communication with the non-transitory memory, wherein the hardware processor is configured to execute the specific computer-executable instructions to at least:
receive input data,
configure a quantum circuit comprising a time evolution operator approximated using Variational Fast Forwarding (VFF) to generate time evolved quantum states, wherein the time evolution operator is associated with a Hamiltonian of the quantum system;
configure the at least one measuring device to measure a quantum state comprising the time evolved quantum states to determine at least one matrix element of an overlap matrix; and
determine the energy of the eigenstate using the at least one matrix element.

2. The quantum computing system of claim 1, wherein the quantum system comprises a molecular system and the Hamiltonian is a molecular Hamiltonian.

3. The quantum computing system of claim 1, wherein the quantum circuit generates the time evolved quantum states using multiple evolution time-steps forming a uniform time grid.

4. The quantum computing system of claim 1, wherein the time evolution operator comprises number preserving quantum gates.

5. The quantum computing system of claim 4, wherein the time evolution operator comprises WDⁿ W^{†} wherein W is a unitary operator, D is a diagonal operator, and n is a number of evolution time steps, and wherein W is parameterized using a symmetry-preserving ansatz.

6. The quantum computing system of claim 5, wherein W is parameterized using the symmetry-preserving ansatz.

7. The quantum computing system of claim 4, wherein a quantum depth of the quantum circuit is independent of a number of evolution time-steps used to generate the time evolved quantum states.

8. The quantum computing system of claim 1, wherein the input data comprises the Hamiltonian.

9. The quantum computing system of claim 1, wherein the time evolved quantum states form a Krylov subspace in a Hilbert space.

10. The quantum computing system of claim 1, wherein the hardware processor determines the energy of the eigenstate using a variational quantum phase estimation (VQPE) algorithm.

11. The quantum computing system of claim 1, wherein the time evolved quantum states comprise approximate time evolved quantum states different from exact time evolved states.

12. A method of operating a quantum computing system for determining an energy of an eigenstate of a quantum system, wherein the quantum computing system comprises a quantum computer in communication with a classical computing system and the classical computing system comprises a hardware processor, the method comprising, by the hardware processor:
receiving input data,
configuring a quantum circuit comprising a time evolution operator approximated using Variational Fast Forwarding (VFF) to generate time evolved quantum states, wherein the time evolution operator is associated with a Hamiltonian of the quantum system;
measuring a quantum state comprising the time evolved quantum states;
determining at least one matrix element of an overlap matrix using the measured quantum state; and
determining the energy of the eigenstate using the at least one matrix element.

13. The method of claim 12, wherein the input data comprises a reference state and determining the at least one matrix element of the overlap matrix comprises determining the at least one matrix element using the reference state.

14. The method of claim 12, wherein generating the time evolved quantum states comprises generating the time evolved quantum states using multiple time-steps, and wherein a quantum depth of the quantum circuit is independent of a number of evolution time-steps used to generate the time evolved quantum states.

15. The method of claim 12, wherein the quantum circuit comprises number preserving quantum gates.

16. The method of claim 15, wherein the time evolution operator comprises WDⁿ W^{†} wherein W is a unitary operator, D is a diagonal operator, and n is a number of evolution time steps, and wherein W is parametrized using a symmetry preserving ansatz.

17. The method of claim 12, wherein determining the at least one matrix element of the overlap matrix comprises determining the at least one matrix element using a Hadamard test protocol.

18. The method of claim 12, wherein the time evolved quantum states form a Krylov subspace in a Hilbert space.

19. The method of claim 12, wherein determining the energy of eigenstates comprises determining the energy of the eigenstates using a variational quantum phase estimation (VQPE) algorithm.

20. A non-transitory computer-readable storage medium comprising specific computer-readable instructions executable on data processing hardware, wherein the specific computer-readable instructions, when executed by the data processing hardware, cause the data processing hardware to perform the method of claim 12.
